(19) United States
(12) Patent Application Publication
(10) Pub. No.: US 2004/0186845 A1
(43) Pub. Date: Sep. 23, 2004

(54) File system for managing files in tree structure allowing users to readily know availability condition

(75) Inventor: Shingo Fukui, Tokyo (JP)

Correspondence Address: OSTROLENK FABER GERB & SOFFEN, 1180 AVENUE OF THE AMERICAS, NEW YORK, NY, 100368403

(73) Assignee: NEC Corporation

(21) Appl. No.: 10/767,780

(22) Filed: Jan. 28, 2004

(30) Foreign Application Priority Data
Jan. 29, 2003 (JP) 2003-020914

(51) Int. Cl. G06F 7/00

(52) U.S. Cl. 707/100

(57) ABSTRACT

An information sharing apparatus is provided for allowing the user to readily understand the availability condition of each of nodes which make up a tree structure. In response to an availability condition manipulation request for changing the availability condition of some node, an execution possibility determination unit refers to the availability condition of each node on a storage device to determine whether or not the availability condition manipulation request can be executed while satisfying the condition that the availability condition may be changed once at maximum on any of all paths from a home root node to respective leaf nodes. An availability condition manipulation unit executes the availability condition manipulation request, if determined as executable by the execution possibility determination unit, such that the condition is satisfied. In response to a tree structure manipulation request for modifying a tree structure, a tree structure manipulation unit refers to the availability condition, and executes the tree structure manipulation request such that the condition is satisfied.

### BACKGROUND OF THE INVENTION

1. Field of the Invention

The present invention relates to a file system for managing information shared by a plurality of users and/or groups in a tree structure, and more particularly, to a file system for managing the availability of information to other users and/or other groups.

2. Description of the Related Art

In an operating system such as Windows and Unix, information owned by users and/or groups is stored in a file system. The file system holds nodes of individual information linked in a tree structure (see Dennis M. Ritchie and Ken Thompson, “The Unix Time Sharing System, Communications of the ACM,” Volume 17, Number 7, July 1974, pp365-375, and Michael M. Swift and Anne Hopkins, “Improving the Granularity of Access Control for Windows 2000,” ACM Transactions on Information and System Security, Volume 5, Number 4, November 2002, pp398-437). The node refers to each piece of information which forms part of a tree structure.

In network storage services provided on WAN such as the Internet, information owned by users and/or groups is often held in a like tree structure.

FIG. 1 illustrates an example of information held in a tree structure. In this example, the tree structure is made up of pieces of information owned by user “Fukui,” user “Tanaka,” group “Cooking Club,” or group “PTA.” In FIG. 1, each information which forms part of the tree structure is a node.

As can be seen from FIG. 1, a unit which owns information may be a user who is an individual person or a group which includes a plurality of persons. However, when it is not necessary to take into consideration whether certain information is owned by a user or a group, a term “unit user” is used herein to refer to both a user and a group.

Generally, a node owned by a certain unit user cannot be accessed by a person who does not belong to the unit user. However, if the unit user who owns of a node sets an access permitted party to the node, the node can be made available for access from persons who do not belong to the unit user.

FIG. 2 is a block diagram illustrating the configuration of a conventional information sharing system. Referring to FIG. 2, the conventional information sharing system comprises input device 1; data processor 3; storage device 4; and output device 2.

Input device 1 may be a keyboard, a mouse, a tablet, or the like. Output device 2 may be a display, a printer, or the like. Storage device 4 stores a variety of information. Data processor 3 executes a software program having data processing capabilities for operations.

Storage device 4 has tree structure storage 9. Tree structure storage 9 stores information owned by each unit user in a tree structure for each unit user. In addition, the tree structure for each unit user may be included in a larger global tree structure as a part thereof.

FIG. 3 shows an exemplary data structure for each of nodes which make up a tree structure. Referring to FIG. 3, each node includes a parent node pointer, a child node pointer list, owner access permission information, an extraneous access permission information list, and the like, in addition to its contents.

The contents refer to arbitrary data such as texts, images, music, binary data, software programs, or the like.

The parent node pointer comprises information for specifying a parent node.

The child node pointer list enumerates child node pointers which comprise information for specifying respective child nodes. The child node pointer list may include a plurality of child node pointers.

FIG. 4 shows an example of owner access permission information. Referring to FIG. 4, the owner access permission information is comprised of the name of the owner of an access permitted node; and access rights to the owner's node such as a read right, a write right, and the like.

FIG. 5 shows an example of extraneous access permission information. Referring to FIG. 5, the extraneous access permission information is comprised of the name of a unit user (i.e., user name or group name) which is permitted to access to a node that is made available to extraneous parties; and access rights to the access permitted node owned by the unit user, including a read right, a write right, and the like. The extraneous access permission information list enumerates extraneous access permission information. The extraneous access permission information list may include a plurality of pieces of extraneous access permission information.

Data processor 3 comprises application execution unit 5; access permission determination unit 6; tree structure manipulation unit 7; and availability condition manipulation unit 8.

Application execution unit 5 executes a variety of applications such as a word processor, a mailing program, a WWW browser, an HTTP server, a Web application server, and the like.

An application executed by application execution unit 5 reads and/or writes nodes held in tree structure storage 9 in a tree structure as required. This read/write manipulations involve, in addition to those manipulations required to read and write contents of a node, tree structure manipulations such as creation of a new node, and duplication, movement, deletion of a node(s), and the like, and availability condition manipulations such as setting or clearing of an access permitted party, setting or clearing of an access right, and the like. The availability condition refers to the values of access permitted party and access rights held in extraneous access permission information set to the node. The availability condition manipulations refer to those manipulations for changing the availability condition of a node.

For reading/writing a node, application execution unit 5 passes a read/write manipulation request to access permission determination unit 6.

Access permission determination unit 6 refers to owner access permission information of a node to be manipulated, and the extraneous access permission information list to determine whether or not the requested read/write manipulation is permitted.

FIG. 6 is a flow chart illustrating the operation of access permission determination unit 6 shown in FIG. 2. Referring to FIG. 6, access permission determination unit 6 first reads the owner access permission information and extraneous access permission information lists of all nodes involved in the manipulation from tree structure storage 9 at step S901. Next, access permission determination unit 6 determines at step S902 whether or not an application executer has an access right to all these nodes. The executer may be an owner of those nodes, or another unit user.

If there is even one node to which the executer does not have an access right, access permission determination unit 6 rejects the execution of the manipulation at step S903. If the executer has an access right to all the nodes, access permission determination unit 6 permits the execution of the manipulation at step 904, and transfers the manipulation request to a module which executes the manipulation.

In response to the permission of the read/write manipulation, the manipulation request is processed in the following manner.

When the manipulation request involves a read/write of contents or access rights, the manipulation request is sent to tree structure storage 9 and processed therein. Also, when the manipulation request involves a manipulation to the tree structure, the manipulation request is sent to tree structure manipulation unit 7 and processed therein. Further, when the manipulation request involves a manipulation to the availability condition, the manipulation request is sent to availability condition manipulation unit 8 and processed therein.

FIG. 7 is a flow chart illustrating the operation of availability condition manipulation unit 8. Availability condition manipulation unit 8 changes an access permitted party of a node under manipulation in accordance with a manipulation request.

Referring to FIG. 7, availability condition manipulation unit 8 determines at step S1001 whether or not a manipulation request involves setting a node as available. If so, availability condition manipulation unit 8 finds the node under manipulation from among tree structure storage 9, and sets an access permitted party to the node at step S1002.

If availability condition manipulation unit 8 determines at step S1001 that the manipulation request does not involve setting a node as available, availability condition manipulation unit 8 determines at step S1003 whether or not the manipulation request involves clearing the availability of a node. If so, availability condition manipulation unit 8 finds the node under manipulation from among tree structure storage 9, and clears the availability of the node at step S1004.

If availability condition manipulation unit 8 determines at step S1003 that the manipulation request does not involve clearing the availability of a node, availability condition manipulation unit 8 notifies an error at step S1005.

FIG. 8 is a flow chart illustrating the operation of tree structure manipulation unit 7. Tree structure manipulation unit 7 creates a new node, or duplicates, moves or deletes a node in accordance with a manipulation request.

Referring to FIG. 8, tree structure manipulation unit 7 classifies a manipulation request in accordance with determinations made at steps S1101, S1103, S1105, S1107.

When the manipulation request involves creating a new node, tree structure manipulation unit 7 creates a new node in tree structure storage 9 at step S1102. When the manipulation request involves duplication of nodes, tree structure manipulation unit 7 creates duplicates of specified nodes under a specified destination node at step S1104.

When the manipulation request involves movement of nodes, tree structure manipulation unit 7 moves specified nodes to a location below specified destination node at step S1106. When the manipulation request involves deletion of a node, tree structure manipulation unit 7 deletes nodes in a maximum partial tree in which the specified node is in position of a root node at step S1108. The root node refers to a node which is finally reached when nodes making up a tree structure are traced toward a parent node in the ascending direction, and may be simply called the “root.” Also, when a subset of nodes, which form part of a tree structure, make up a tree, this tree is called a “partial tree.” The maximum partial tree refers to a partial tree comprised of a specified node and all nodes, which can be reached when the tree structure is traced from the specified node toward child nodes in the descending direction. If the manipulation request does not involve any of the foregoing manipulations, tree structure manipulation unit 7 notifies an error at step S1109.

FIG. 9 illustrates an example of availability condition for each of nodes in a tree structure managed by the conventional information sharing system. Each of the nodes in the tree structure stored in tree structure storage 9 can be made available to unit users other than its owner. In FIG. 9, unit users which are permitted to access the respective node are indicated by alphabet characters written above the associated nodes. In the illustrated example, nodes N1, N2, N3, N4 are made available to unit user B. Also, nodes N5, N6, N7 are made available to unit user B and unit user C. Nodes N8, N9, N10 are made available to unit user D. Nodes N16, N17 are available to unit user E and unit user F.

In this way, the conventional information sharing system permits arbitrary nodes to be available to arbitrary unit users. As illustrated in FIG. 9, in each of nodes which exist on a path from a home root node (N0) to a leaf node, the access permitted parties or unit users change many times while the path is traced. A home root node refers to a root node of an overall tree structure owned by a unit user. A leaf node refers to a node which has no child node, and may be simply called the “leaf.” For example, paying attention to a path from home root node N0 to leaf node N6, node N0 is not made available, nodes N1, N2 are made available to unit user B, and nodes N5, N6 are made available to unit users B, C. In other words, access permitted parties change twice on this path.

FIG. 10 is a diagram which divides the tree structure illustrated in FIG. 9 into several regions for simplicity in order to readily recognize the unit users which are permitted to access to the nodes in the respective regions. It can be also seen, with reference to FIG. 10, that there are paths on which access permitted parties change a plurality of times.

According to the conventional information sharing system described above, an owner can freely set an access permitted party to each node. However, when a multiplicity of pieces of information are managed by the information sharing system, complicated and time-consuming works are required for setting an access permitted party for each of nodes.

To relieve the complexity, an information sharing system employs an inheritance function with which a child node inherits an access permitted party set to a parent node. The use of the inheritance function can eliminate the setting of an access permitted party to a node which inherits the access permitted parity of the parent node.

FIG. 11 illustrates an exemplary tree structure which is managed by the information sharing system that employs the inheritance function. In FIG. 11, a node marked with “◯” above its right shoulder is a node which inherits an access permitted party set to its parent node. On the other hand, a node marked with “ ” its right shoulder is a node which does not inherit an access permitted party set to its parent node.

In the example illustrated in FIG. 11, nodes N0, N1, N8, N5, N16, N18 do not inherit the access permitted party of the parent node. The remaining nodes inherit the access permitted party or parties of their parent nodes. This information sharing system allows an owner to freely set an access permitted party to each node, in a manner similar to that illustrated in FIG. 9, by setting the access permitted party only to nodes N0, N1, N5, N8, N16, N18 which do not inherit the access permitted party of their parent nodes.

The foregoing prior art systems, however, has the following problems left unsolved.

In the conventional information sharing system using the inheritance function, in order to know an access permitted party of each of nodes which make up an arbitrary partial tree, it is necessary to examine access permitted parties of all nodes which make up the partial tree, on a node-by-node basis, using access permission information and inheritance information. For example, in FIG. 11, for knowing an access permitted party or parties of each of nodes which make up a partial tree in which node N1 is in position of the root, all nodes N2-N10 must be examined in the partial tree, thus requiring complicated works.

Also, in this conventional information sharing system, for predicting how a change in access permitted party of an arbitrary node will cause further changes in access permitted party of each of nodes which make up a partial tree in which the arbitrary node is in position of the root, it is necessary to previously examine all access permission information and inheritance information on the nodes which make up the partial tree in which the arbitrary node is in position of the root, thus requiring complicated works.

Further, in the conventional information sharing system, similar problems to the foregoing also arise when an arbitrary partial tree is moved.

### SUMMARY OF THE INVENTION

It is an object of the present invention to provide an information sharing method and apparatus which allow a user to readily set an access permitted party to each of nodes which make up a tree structure, to readily know the availability condition of each node, and to readily determine a change in the availability condition of each node caused by a manipulation, and a program which embodies the information sharing method.

To achieve the above object, the information sharing apparatus of the present invention holds information owned by at least one unit user on a storage device in a tree structure for each unit user which has a home root node, at least one leaf node, and a plurality of nodes arranged in sequence from the home root node to each leaf node, such that the information corresponds to each of the nodes, to manage the availability condition for each node.

The information sharing apparatus includes execution possibility determining means, availability condition manipulating means, and tree structure manipulating means.

The execution possibility determining means refers to the availability condition of each of the nodes on the storage device in response to an availability condition manipulation request for changing the availability condition of some node, to determine whether or not the availability condition manipulation request can be executed while satisfying a condition that the number of times of changes in the availability condition is limited to one at maximum on all paths from the home root node to the respective leaf nodes. The availability condition manipulating means executes the availability condition manipulation request, when determined as executable in the execution possibility determining means, such that the condition is satisfied. The tree structure manipulating means refers to the availability condition in response to a tree structure manipulation request for modifying the tree structure to execute the tree structure manipulation request such that the condition is satisfied.

In this event, when the availability condition manipulation request involves setting an availability condition, the execution possibility determining means determines that the availability condition manipulation request is executable when the availability condition of a node under manipulation is the same as that of the home root node, or is a change start point of the availability condition in the tree structure, and the execution possibility determining means determines that the availability condition manipulation request is not executable when the availability condition of the node under manipulation is different from that of the home root node, and is not a change start point.

When the availability condition manipulation request involves clearing an availability condition, the execution possibility determining means determines that the availability condition manipulation request is executable when a node under manipulation is a change start point of the availability condition in the tree structure, and determines that the availability condition manipulation request is not executable when the node under manipulation is not a change start point.

The execution possibility determining means determines that the availability condition manipulation request is not executable when a node under manipulation intended by the availability condition manipulation request is a home root node.

The information sharing apparatus further includes availability condition setting supporting means which, when called from the availability condition manipulating means, sets the same availability condition of a node under manipulation to all nodes included in a maximum partial tree in which the node under manipulation is in position of a root. When the availability condition manipulation request involves setting an availability condition, the availability condition manipulating means sets the availability condition of a node under manipulation as requested by the availability condition manipulation request, and then calls the availability condition setting supporting means.

The information sharing apparatus further includes availability condition clear supporting means which, when called from the availability condition manipulating means, sets the same availability condition of a node under manipulation to all nodes included in a maximum partial tree in which the node under manipulation is in position of a root. When the availability condition manipulation request involves clearing availability information, the availability condition manipulating means clears the availability of a node under manipulation, and then calls the availability condition clear supporting means.

When the tree structure manipulation request involves creating a new node, the tree structure manipulating means creates the new node at a requested location.

The information sharing apparatus further includes new node creation supporting means which, when called from the tree structure manipulating means, sets the same availability condition of a parent node to the new node. The tree structure manipulating means calls the new node creation supporting means after creating the new node.

When the tree structure manipulation request involves duplicating a node group comprising at least one node, the tree structure manipulating means creates a duplicate of the node group at a requested location.

The information sharing apparatus further includes duplication supporting means which, when called from the tree structure manipulating means, sets the same availability condition, set to the parent node of a root node of the node group, to the nodes which make up the duplicate of the node group. The tree structure manipulating means calls the duplication supporting means after creating the duplicate of the node group.

When the tree structure manipulation request involves moving a node group comprising at least one node, the tree structure manipulating means moves the node group to a location under a requested destination node.

The information sharing apparatus further includes movement supporting means which, when called from the tree structure manipulating means, performs different processing depending on whether or not the availability condition of a destination node is different from that of the home root node. The tree structure manipulating means calls the movement supporting means after moving the node group.

The above and other objects, features, and advantages of the present invention will become apparent from the following description with reference to the accompanying drawings which illustrate examples of the present invention.

### BRIEF DESCRIPTION OF THE DRAWINGS

FIG. 1 is a diagram illustrating an example of information held in a conventional tree structure;

FIG. 2 is a block diagram illustrating a conventional information sharing system;

FIG. 3 is a table showing an exemplary data structure for each of nodes which make up a tree structure;

FIG. 4 is a diagram showing an example of owner access permission information;

FIG. 5 is a diagram showing an example of extraneous access permission information;

FIG. 6 is a flow chart illustrating the operation of an access permission determination unit shown in FIG. 2;

FIG. 7 is a flow chart illustrating the operation of an availability condition manipulation unit shown in FIG. 2;

FIG. 8 is a flow chart illustrating the operation of a tree structure manipulation unit shown in FIG. 2;

FIG. 9 is a diagram illustrating, by way of example, nodes which are made available to unit users in a tree structure managed by the conventional information sharing system;

FIG. 10 is a diagram which divides the tree structure illustrated in FIG. 9 into several regions for simplicity in order to readily recognize access permitted parties of the nodes in the respective regions;

FIG. 11 is a diagram illustrating an exemplary tree structure managed by an information sharing system which uses an inheritance function;

FIG. 12 is a diagram illustrating an example of information managed in a tree structure, to which is directed the present invention;

FIG. 13 is a diagram showing an exemplary tree structure which satisfies the condition imposed in the present invention;

FIG. 14 is a diagram which divides the tree structure illustrated in FIG. 13 into several regions for simplicity in order to readily recognize access permitted parties of the nodes in the respective regions;

FIG. 15 is a diagram illustrating another exemplary tree structure which satisfies the condition imposed in the present invention;

FIG. 16 is a diagram showing a simplified representation of the availability situation of the information shown in FIG. 15;

FIG. 17 is a diagram illustrating several regions divided from an exemplary tree structure which satisfies the condition imposed in the present invention;

FIG. 18 is a diagram illustrating several regions divided from another exemplary tree structure which satisfies the conditions imposed in the present invention;

FIG. 19 is a block diagram illustrating an information sharing system according to one embodiment of the present invention;

FIG. 20 is a table showing an exemplary data structure for each of nodes which make up a tree structure;

FIG. 21 is a diagram showing an example of owner access permission information;

FIG. 22 is a diagram showing an example of extraneous access permission information;

FIG. 23 is a table showing an example of information stored in a node;

FIG. 24 is a flow chart illustrating the operation of an access permission determination unit;

FIG. 25 is a flow chart illustrating the operation of an execution possibility determination unit;

FIG. 26 is a flow chart illustrating the operation of an availability condition manipulation unit;

FIG. 27 is a flow chart illustrating the operation of a tree structure manipulation unit;

FIG. 28 is a flow chart illustrating the operation of an availability set/clear support unit;

FIG. 29 is a flow chart illustrating the operation of a new node creation support unit;

FIG. 30 is a flow chart illustrating the operation of a duplication support unit;

FIG. 31 is a flow chart illustrating the operation of a movement support unit;

FIG. 32 is a diagram illustrating a manipulation for writing a content;

FIG. 33 is a diagram illustrating a manipulation for creating a new node;

FIG. 34 is a diagram illustrating how a new node has been incorporated in the tree structure in the new node creation manipulation;

FIG. 35 is a diagram illustrating access permitted parties which have been set to a created node in the new node creation manipulation;

FIG. 36 is a diagram illustrating a duplication manipulation;

FIG. 37 is a diagram illustrating how duplicated nodes are incorporated in the tree structure in the duplication manipulation;

FIG. 38 is a diagram illustrating access permitted parties which have been set to the duplicated nodes in the duplication manipulation;

FIG. 39 is a diagram illustrating a movement manipulation;

FIG. 40 is a diagram illustrating nodes which have been moved in the tree structure in the movement manipulation;

FIG. 41 is a diagram illustrating access permitted parties which have been set to the moved nodes in the movement manipulation;

FIG. 42 is a diagram illustrating a deletion manipulation;

FIG. 43 is a diagram illustrating the tree structure after nodes have been deleted therefrom in the deletion manipulation;

FIG. 44 is a diagram illustrating a setting manipulation;

FIG. 45 is a diagram illustrating an access permitted party which has been set to a node under manipulation in the setting manipulation;

FIG. 46 is a diagram illustrating how the same access permitted party of the node under manipulation is set to nodes included in a maximum partial tree in which the node under manipulation is in position of the root in the setting manipulation;

FIG. 47 is a diagram illustrating a manipulation for adding an access permitted party;

FIG. 48 is a diagram illustrating an access permitted party added to the node under manipulation in the manipulation for adding an access permitted party;

FIG. 49 is a diagram illustrating how the same access permitted party of the node under manipulation is set to nodes included in a maximum partial tree in which the node under manipulation is in position of the root in the manipulation for adding an access permitted party;

FIG. 50 is a diagram illustrating a manipulation for deleting an access permitted party;

FIG. 51 is a diagram illustrating that an access permitted party has been deleted from a node under manipulation in the manipulation for deleting an access permitted party;

FIG. 52 is a diagram illustrating how the same access permitted party of the node under manipulation is set to nodes included in a maximum partial tree in which the node under manipulation is in position of the root in the manipulation for deleting an access permitted party;

FIG. 53 is a diagram illustrating a manipulation for clearing an access permitted party;

FIG. 54 is a diagram illustrating a tree structure in which an access permitted party for a node under manipulation has been cleared in the manipulation for clearing an access permitted party;

FIG. 55 is a diagram illustrating how the same access permitted party of the node under manipulation is set to nodes included in a maximum partial tree in which the node under manipulation is in position of the root in the manipulation for clearing an access permitted party;

FIG. 56 is a diagram illustrating how a movement manipulation is classified according to the availability condition of nodes to be moved;

FIG. 57 is a diagram illustrating a movement manipulation is classified according to the availability condition of a destination node;

FIG. 58 is a diagram schematically illustrating Case 1 in the movement manipulation;

FIG. 59 is a diagram schematically illustrating Case 2 in the movement manipulation;

FIG. 60 is a diagram schematically illustrating Case 3 in the movement manipulation;

FIG. 61 is a diagram schematically illustrating Case 4 in the movement manipulation;

FIG. 62 is a diagram schematically illustrating Case 5 in the movement manipulation;

FIG. 63 is a diagram schematically illustrating Case 6 in the movement manipulation;

FIG. 64 is a diagram schematically illustrating Case 7 in the movement manipulation;

FIG. 65 is a diagram schematically illustrating Case 8 in the movement manipulation;

FIG. 66 is a list showing processing performed by a movement support unit in the respective cases in the movement manipulation;

FIG. 67 is a table showing an exemplary data structure for each of nodes managed by an information sharing system according to another embodiment of the present invention;

FIG. 68 is a diagram showing an example of information stored in a node when the data structure shown in FIG. 67 is used;

FIG. 69 is a block diagram illustrating an information sharing system according to a further embodiment of the present invention;

FIG. 70 is a diagram illustrating an exemplary availability situation for nodes when short-cut is used;

FIG. 71 is a diagram showing a simplified representation of the availability situation illustrated in FIG. 70;

FIG. 72 is a diagram illustrating an exemplary tree structure which has nested access permitted parties; and

FIG. 73 is a block diagram illustrating an information sharing system according to a further embodiment of the present invention.

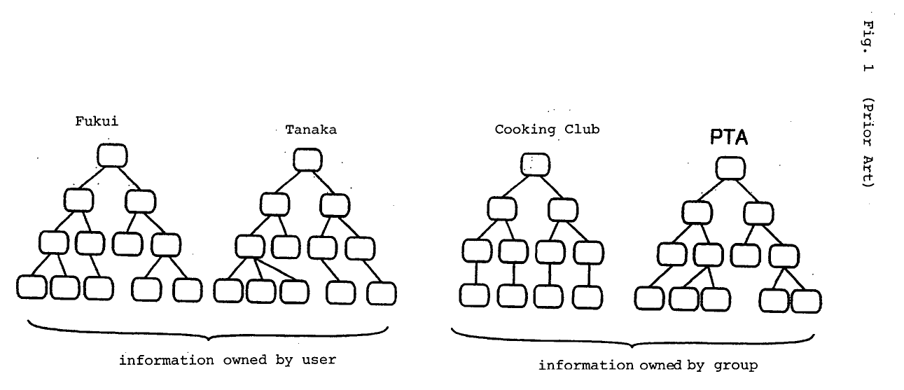

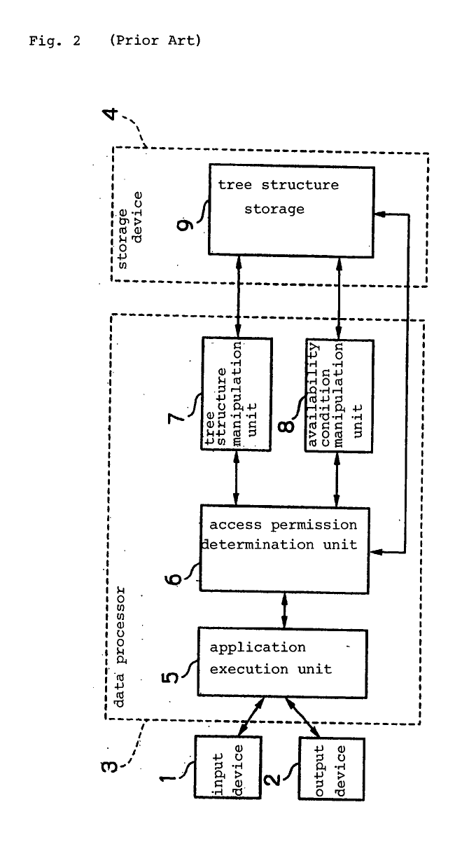

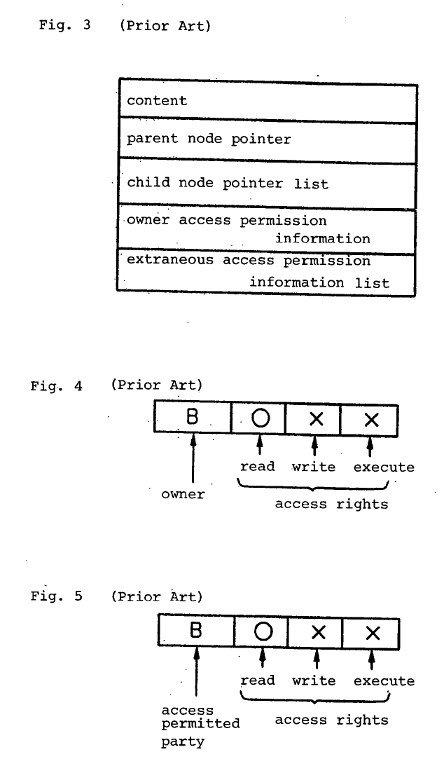

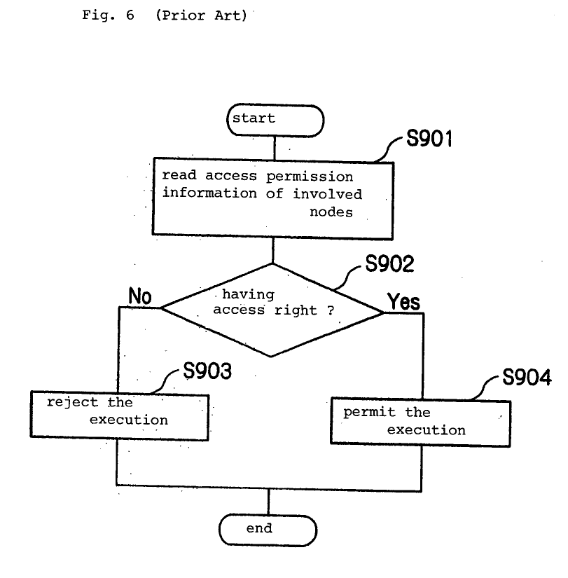

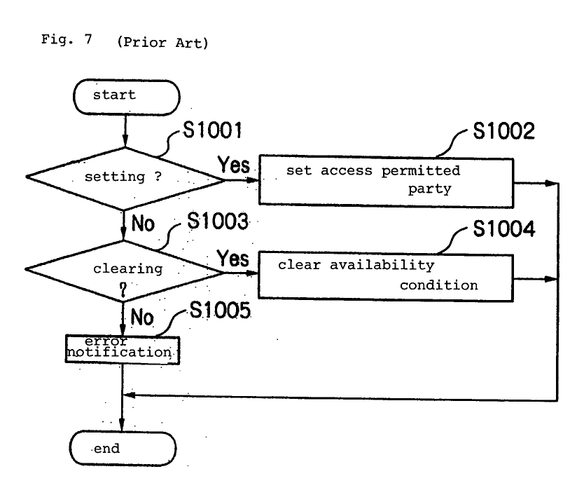

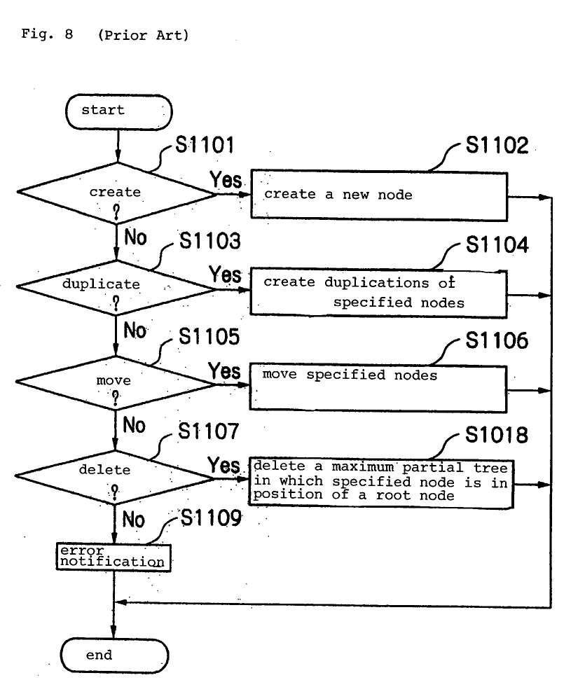

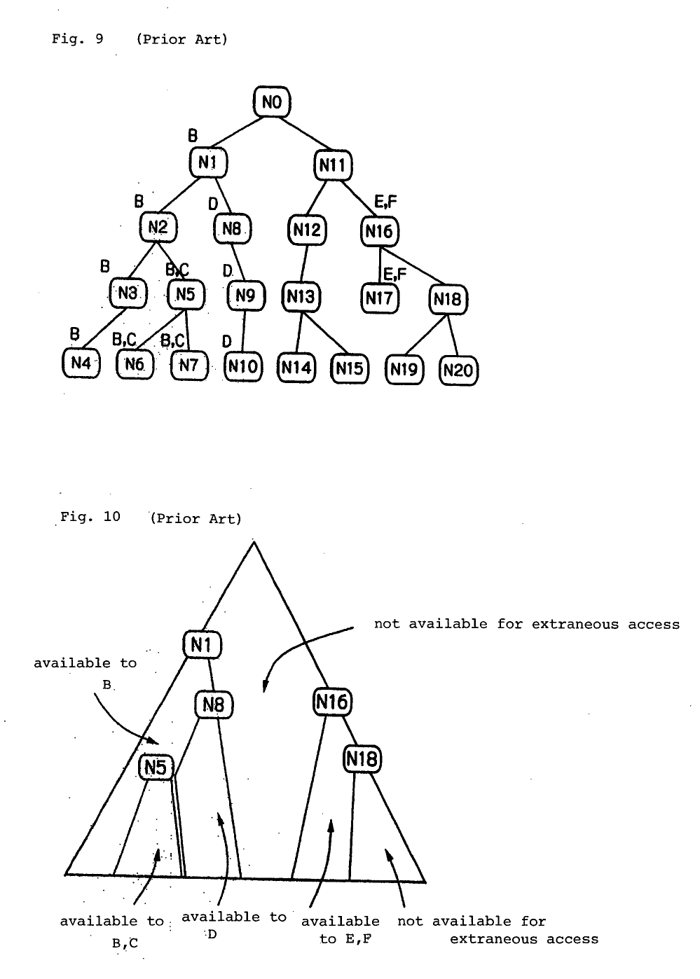

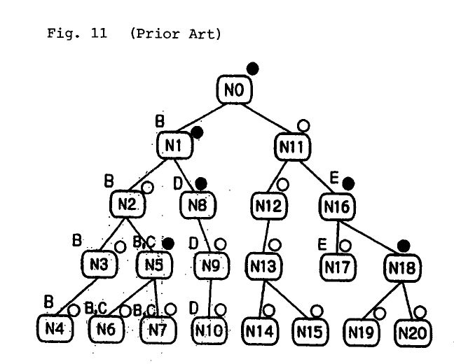

### EMBODIMENTS

An information sharing system according to the present invention manages information owned by users and groups in a tree structure which has at least one node. When the user and group need not be distinguished from each other, both the user and group are called the “unit user.”

An owner can make part or all of information owned thereby available to other unit users. Unit users which are permitted to access such information can access the information. However, the information sharing system of the present invention imposes an upper limit to the number of times access permitted parties can be changed on any of all paths from a root node to a leaf node. Specifically, when an access permitted party is set to a particular node, a change in the access permitted party is limited to once or less on any of all paths from the root node to the respective leaf nodes in a tree structure.

This condition facilitates determination and prediction as to which information is made available to which party when a user changes the availability of information, or when the user changes the shape of a tree structure of information.

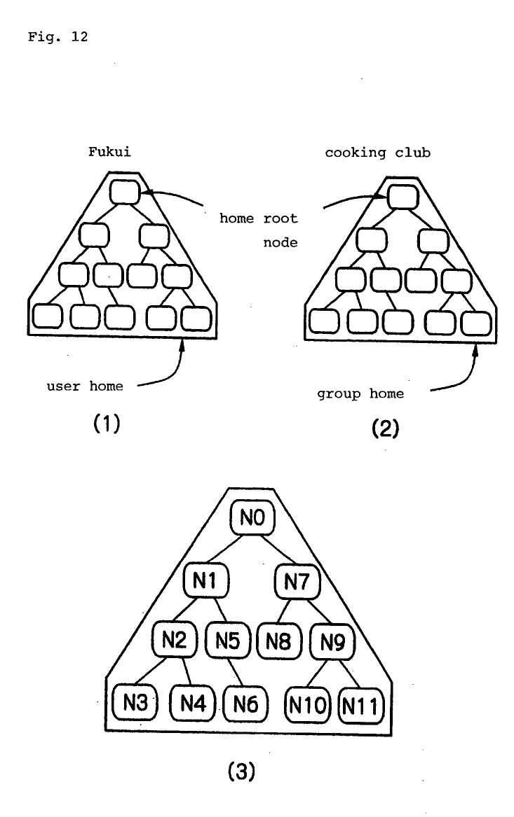

FIG. 12 is a diagram illustrating an example of information managed in a tree structure, to which is directed the present invention.

Referring to FIG. 12, a node refers to each piece of information which forms part of the tree structure. A root node refers to a node which is finally reached when nodes, making up a tree structure, are traced toward a parent in the ascending direction. The root node may be simply called the “root.” A leaf node refers to a node which has no child node. The leaf node may be simply called the “leaf.”

As illustrated in FIG. 12(1), an overall tree structure made up of information owned by a single user is called a “user home.” As illustrated in FIG. 12(2), an overall tree structure made up of information owned by a single group is called a “group home.” When the user and group need not be particularly distinguished from each other, an overall tree structure made up of information owned by a unit user is called a “home.” A root node of a tree structure which comprises a home is called a “home root node.”

A partial tree refers to a subset of nodes which make up a tree structure, when they make up a tree. For example, in a tree structure of FIG. 12(3), nodes N1, N2, N5, N6 make up a partial tree.

A partial tree is called a “partial tree in which node X is in position of the root” when the partial tree includes node X itself or any node which can be reached when the partial tree is traced from node X toward child nodes. For example, in the tree structure of FIG. 12(3), a partial tree made up of nodes N7, N8, N9, and a partial tree made up of nodes N7, N8, N9, N10 are both partial trees in which node N7 is in position of the root.

A partial tree made up of node X and all nodes which can be reached when the original tree is traced from node X toward child nodes is called a “maximum partial tree in which node X is in position of the root.” For example, in the tree structure of FIG. 12(3), a maximum partial tree in which node N7 is in position of the root is made up of nodes N7, N8, N9, N10, N11.

In the following description, the user is not particularly distinguished from the group. Also, a unit user name (i.e., user name or group name) is designated by one capital letter of the alphabet A-F.

FIG. 13 is a diagram illustrating an exemplary tree structure which satisfies the condition imposed in the present invention. In FIG. 13, each of nodes in a tree structure which comprises a home can be made available to unit users other than the owner. In FIG. 13, access permitted parties for each node are designated by alphabet characters marked above each node. In this example, nodes N1, N2, N3, N4, N5, N6, N7, N8, N9, N10 are made available to unit user B. Likewise, nodes N16, N17, N18, N19, N20 are made available to unit users E, F.

As illustrated in FIG. 13, at each of nodes existing on a path from the home root node (N0) to each leaf node, the access permitted party changes once at maximum while these nodes are traced. For example, paying attention to a path from home root node N0 to leaf node N4, node N0 is not made available, but nodes N1, N2, N3, N4 are made available to unit user B. In other words, on this path, the access permitted party changes only once between nodes N0 and N1.

Likewise, since all paths extending to leaf nodes N6, N7, N10 pass node N1, nodes N5, N6, N7, N8, N9, N10 must be made available to the same unit user B as node N1. Stating this condition in another way, when certain node X is made available to a different unit user, nodes belonging to a maximum partial tree, in which node X is in position of the root, should be made available to the same unit user as node X. In FIG. 13, node N11 is not made available to any unit user, while node N16 is made available to unit users E, F, so that there is a change in access permitted party. Therefore, each of nodes making up a maximum partial tree which has node N16 at the position of root, i.e., Nodes N16, N17, N18, N19, N20 are made available to the same access permitted parties (unit users E, F) as node N16.

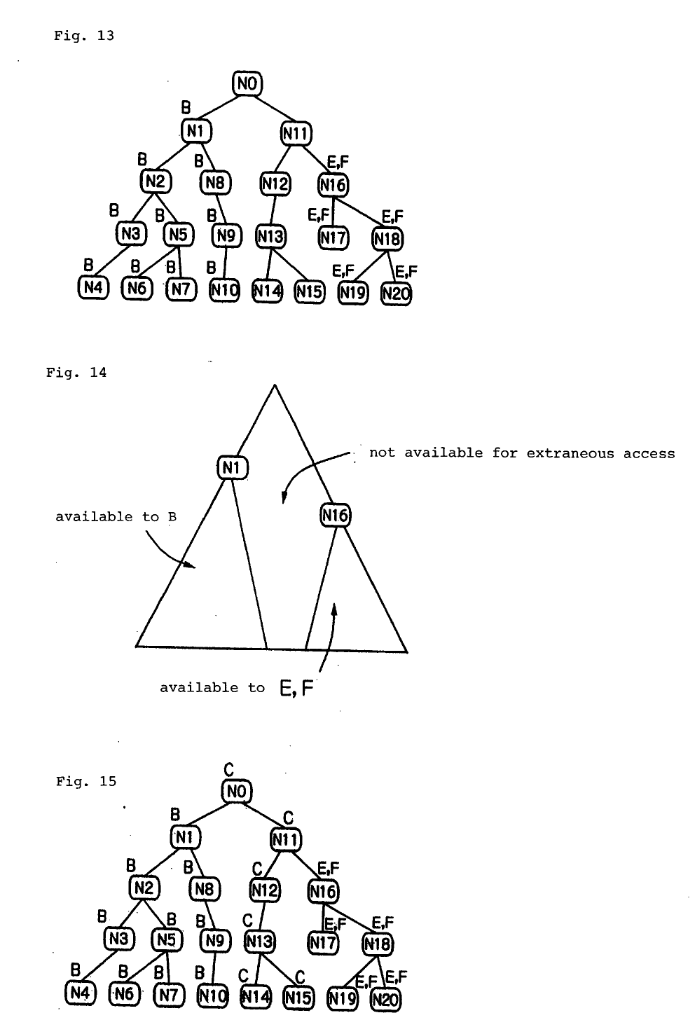

FIG. 14 is a diagram which divides the tree structure illustrated in FIG. 13 into several regions for simplicity in order to readily recognize access permitted parties of nodes in the respective regions. It can be seen in FIG. 14 that there is only one change in the availability to a unit user(s) in each region.

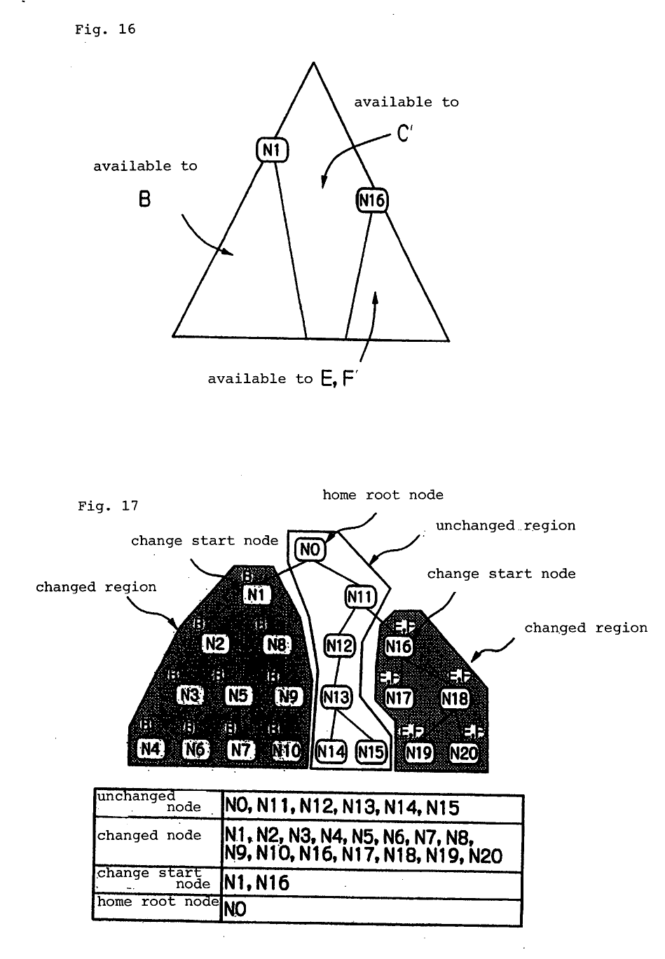

In the example illustrated in FIG. 13, node N0 is not made available to any unit user. Conversely, when node N0 is made available to certain unit user, a tree structure can be made up as well under the condition that “on each of paths from the root node (N0) to respective leaf nodes of a tree structure, the access permitted party changes once at maximum while the path is traced.” FIG. 15 illustrates such an example, where unit user C is set as an access permitted party of node N0. In this event, nodes N1, N16 are made available to different access permitted parties, so that the illustrated example of tree structure also satisfies the condition as is the case with the tree structure in FIG. 13. FIG. 16 is a diagram illustrating the availability situation of the information shown in FIG. 15.

FIG. 17 is a diagram illustrating an exemplary tree structure which satisfies the condition of the present invention. Nodes which have the same access permitted party as a home root node, and the home root node itself (nodes N0, N11, N12, N13, N14, N15 in FIG. 17) are called “unchanged node.” The remaining nodes are called “changed nodes.”

A region occupied by unchanged nodes is called an. “unchanged region,” while a region occupied by changed nodes is called a “changed region.” The changed node which appears first when a tree structure is traced from the home root node in sequence is called a “change start node.” In the tree structure of FIG. 17, nodes N1, N16 are change start nodes.

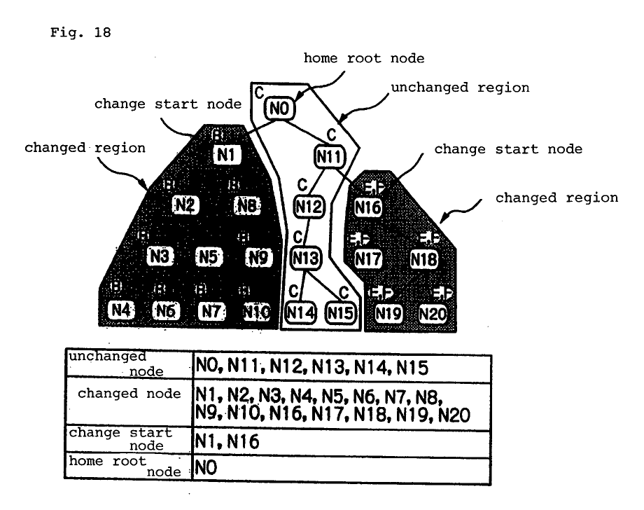

While FIG. 17 has illustrated an example in which the home root node is not made available to any party, the same terms can also be used when the home root node is made available to some party, as illustrated in FIG. 18 (it is made available to unit user C in FIG. 18).

The information sharing system must satisfy at all times the condition dictating that “on each of paths from the root node to respective leaf nodes of a tree structure, the access permitted party changes once at maximum.” For this purpose, the information sharing system sets an access permitted party to each node such that the condition is satisfied when the system performs a manipulation which involves changing the tree structure (creating a new node, duplicating a node, moving a node), and a manipulation which involves changing the availability condition (setting the availability, changing the availability, clearing the availability).

Therefore, according to the information sharing system of the present invention, upon detection of a node which is made available to a different unit user, it can be determined that nodes belonging to an overall maximum partial tree having that node in position of the root is made available to the same unit user, so that the user need not examine access permitted parties set to all nodes which make up the partial tree.

Also, the foregoing condition is maintained when an access permitted party is set or cleared, and when a tree structure manipulation has been made such as creation of a new node, movement of a node, or deletion of a node, thereby avoiding complicated setting of access permitted parties to reduce a burden on the user who utilizes the system.

Next, one embodiment of the present invention will be described in detail with reference to the accompanying drawings.

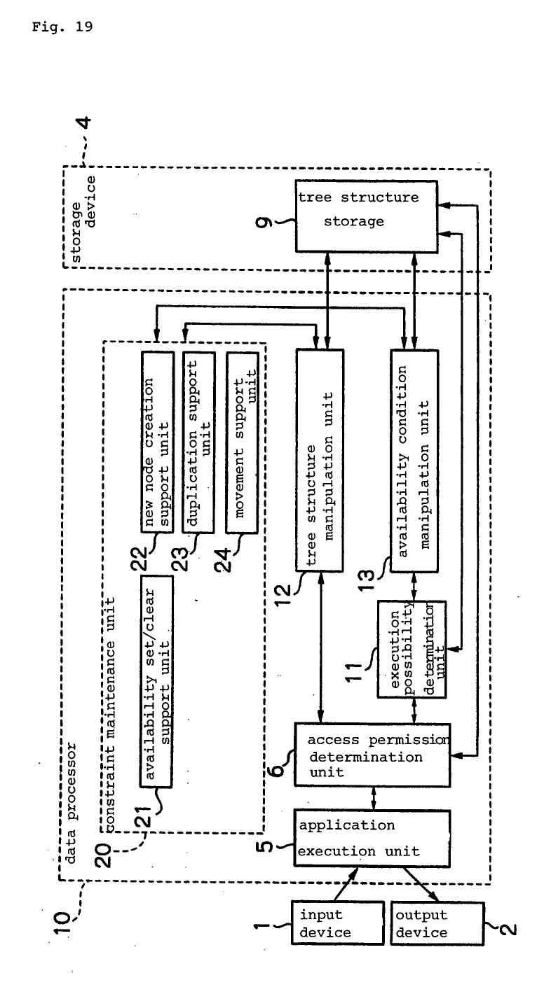

FIG. 19 is a block diagram illustrating an information sharing system according to one embodiment of the present invention. Referring to FIG. 19, the information sharing system of this embodiment comprises input device 1, data processor 10, storage device 4, and output device 2.

Input device 1 may be a keyboard, a mouse, a tablet, or the like. Output device 2 may be a display, a printer, or the like. Storage device 4 stores a variety of information. Data processor 10 may be a computer which executes a software program having a variety of processing for operations.

Storage device 4 has tree structure storage 9. Tree structure storage 9 stores information owned by each unit user in the form of a tree structure on a user-by-user basis.

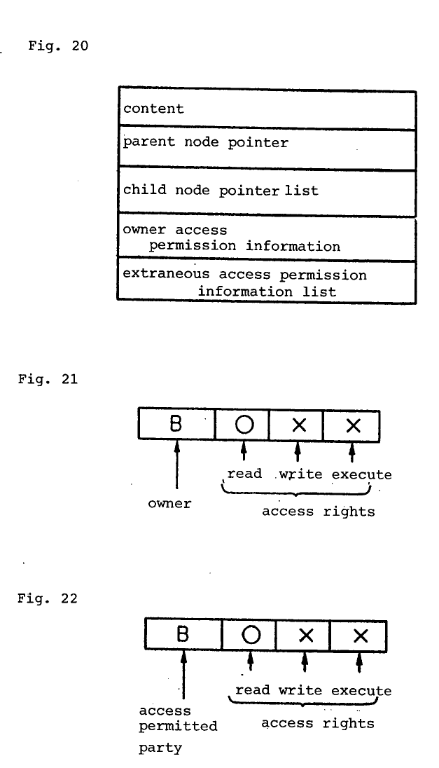

FIG. 20 is a table showing a data structure for each of nodes which make up a tree structure. Referring to FIG. 20, each node includes a parent node pointer, a child node pointer list, owner access permission information, an extraneous access permission information list, and the like, other than its contents.

The contents refer to arbitrary data such as texts, images, music, binary data, software programs, and the like.

The parent node pointer comprises information for specifying a parent node.

The child node pointer list enumerates child node pointers which comprise information for specifying respective child nodes. The child node pointer list may include a plurality of child node pointers.

FIG. 21 shows an example of owner access permission information. Referring to FIG. 21, the owner access permission information is comprised of the name of the owner of an access permitted node; and access rights to the owner's node such as a read right, a write right, and the like.

FIG. 22 shows an example of extraneous access permission information. Referring to FIG. 22, the access permitted information is comprised of the name of a unit user which is permitted to access the node; and access rights to the node which is made available for access, including a read right, a write right, and the like, permitted to the access permitted party. The extraneous access permission information list enumerates extraneous access permission information. The extraneous access permission information list may include a plurality of pieces of extraneous access permission information.

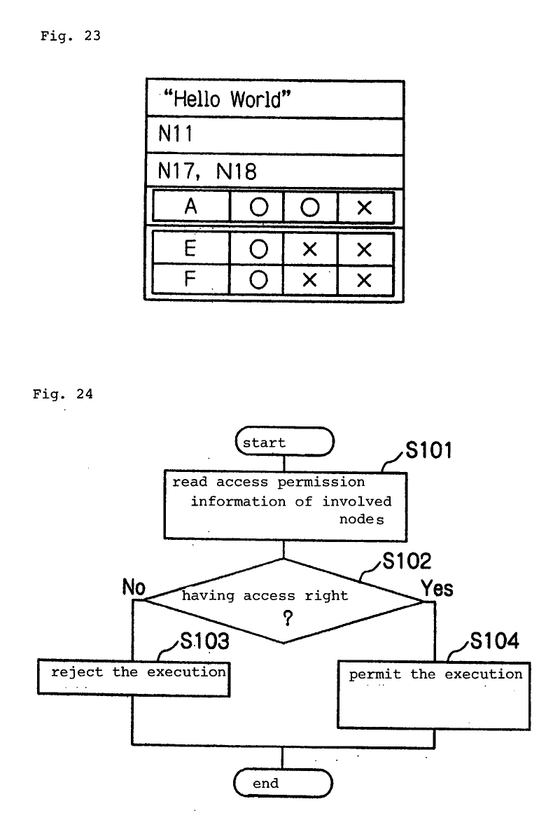

FIG. 23 is a table showing an example of information stored in a node. Each of fields shown in FIG. 23 matches with that in FIG. 20. FIG. 23 illustrates information stored in node N16 in FIG. 13. Specifically, the content is “Hello World”; a parent node pointer points to node N11; and child node pointers included in the child node pointer list point to nodes N17, N18, respectively. Also, the owner access permission information indicates that the owner is unit user A, and a read manipulation and a write manipulation are permitted. Further, the extraneous access permission information list shows that unit users E, F, which are access permitted parties, are permitted to perform a read manipulation.

Generally, in the information sharing system, the availability is set in units of information sets (partial trees). Then, the information sharing system individually sets which access right (read right, write right, and the like) is given to which of information that is made available. Therefore, a unit user, which is an owner, first recognizes access permitted parties on a partial tree basis, and then recognizes access rights to individual data given to each unit user. While the access rights may be automatically given by using default values or the inheritance function, access permitted parties are explicitly set by the owner unit user.

Here, attention is paid to how to readily change a unit user which has been set as permitted to access a node, and how to readily determine which information is made available to which unit user, and the following description will be made to show how to handle an access permitted party held by a node.

Data processor 10 comprises application execution unit 5, access permission determination unit 6, execution possibility determination unit 11, tree structure manipulation unit 12, availability condition manipulation unit 13, and constraint maintenance unit 20.

Constraint maintenance unit 20 comprises availability set/clear support unit 21, new node creation support unit 22, duplication support unit 23, and movement support unit 24.

Application execution unit 5 provides a function of executing a variety of applications such as a word processor, a mailing program, a WWW browser, an HTTP server, a Web application server, and the like. An application executed by application execution unit 5 reads and/or writes information in a tree structure stored in tree structure storage 9 as required. The read/write of information in the tree structure involves manipulations for reading/writing contents of a node; tree structure manipulations such as creation of a new node, and duplication, movement, deletion of a node(s), and the like; and availability condition manipulations such as setting or clearing of an access permitted party of a node, setting or clearing of an read/write right, and the like. The availability condition includes access permitted parties of nodes, and the access right such as read, write, and the like. In this embodiment, an example is shown particularly bearing in mind access permitted parties of nodes. The availability condition manipulations refer to those manipulations for changing the availability condition of a node. For reading/writing information in the tree structure, application execution unit 5 passes a read/write request to access permission determination unit 6.

Access permission determination unit 6 refers to owner access permission information and the extraneous access permission information list of an associated node to determine whether or not the requested read/write manipulation is permitted.

When the read/write manipulation is permitted, the manipulation request is processed in the following manner. When the manipulation request involves a read/write of contents or an access right, the manipulation request is sent to tree structure storage 9 and processed therein. When the manipulation request involves a manipulation to the tree structure, the manipulation request is sent to tree structure manipulation unit 12 and processed therein. When the manipulation request involves a manipulation to the availability condition, the manipulation request is sent to execution possibility determination unit 11 and processed therein.

Execution possibility determination unit 11 refers to the position of a node under manipulation in the tree structure, and an availability setting situation to determine whether or not the availability condition can be manipulated. When execution possibility determination unit 11 determines that the manipulation is possible, the manipulation request is sent to availability condition manipulation unit 13 and processed therein.

Availability condition manipulation unit 13 changes an access permitted party of the node under manipulation in accordance with the manipulation request, and then sends the manipulation request to availability set/clear support unit 21 within constraint maintenance unit 20.

Tree structure manipulation unit 12 creates a new node, duplicates, or moves or deletes a node in accordance with the contents of the manipulation request, and then sends the manipulation request to one of new node creation support unit 22, duplication support unit 23 and movement support unit 24 in accordance with the contents of the manipulation request. When the manipulation request involves a deletion manipulation, the request is not forwarded.

Availability set/clear support unit 21, upon receipt of the manipulation request, sets an access permitted party held in the node under manipulation to those nodes which belong to a maximum partial tree in which the node under manipulation is in position of the root.

New node creation support unit 22 sets an access permitted party of the parent node to a newly created node.

Duplication support unit 23 sets the access permitted party held in the parent node of a root node of nodes created by a duplication manipulation to these duplicated nodes.

Movement support unit 24 reads an access permitted party of a destination node to set it to all nodes which are to be moved in the following two cases: (1) when the destination node is a changed node; and (2) when the destination node is an unchanged node, the root node of the nodes to be moved is a changed node, and the root node of the nodes to be moved is not a change start node.

In the following, the operation of the information sharing system according to this embodiment and its respective components will be described in detail.

The information owned by each unit user is stored in tree structure storage 9. The information owned by a unit user forms a tree structure.

Application execution unit 5 provides a function of executing a variety of applications such as a word processor, a mailing program, a WWW browser, an HTTP server, a Web application server, and the like. An application executed by application execution unit 5 performs an input/output operation using input device 1 and/or output device 2 as required, and reads and/or writes information on a tree structure stored in tree structure storage 9 as required. This read/write manipulations involve, in addition to those manipulations required to read and write contents of a node, tree structure manipulations including creation of a new node, and duplication, movement, deletion of a node(s), and the like, and availability condition manipulations including setting or clearing of an access permitted party of a node, setting or clearing of an access right, and the like. For reading/writing information in a tree structure, application execution unit 5 first passes a read/write manipulation request to access permission determination unit 6.

FIG. 24 is a flow chart illustrating the operation of access permission determination unit 6. Referring to FIG. 24, access permission determination unit 6 first reads the access permission information of all nodes associated with a manipulation from tree structure storage 9 (step S101). Next, access permission determination unit 6 determines whether or not an application executer has an access right to all these nodes (step S102).

If the application executer has an access right to all the nodes, access permission determination unit 6 permits the execution of the manipulation, and forwards the manipulation request to a module which actually executes the manipulation (step S104). If there is even one node to which the application executer does not have an access right, the access permission determination unit 6 rejects the execution of the manipulation (step S103).

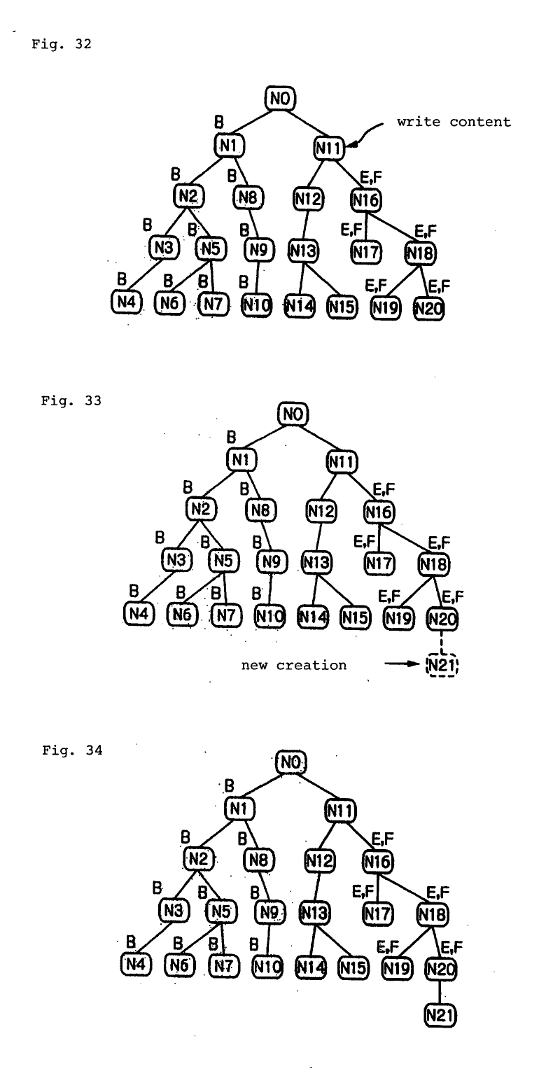

The “nodes associated with the manipulation” read at step S101 differ depending on the contents of a requested manipulation. When the requested manipulation involves reading/writing content information, nodes associated with the manipulation are those nodes which are to be read and/or written. For example, in a manipulation for writing a content of node N11, illustrated in FIG. 32, it is only node N11 which is associated with the manipulation.

When the requested manipulation involves creation of a new node, a node associated with the manipulation is a node which is the parent of the newly created node. For example, in a manipulation for newly creating node N21 under node N20 illustrated in FIG. 33, the node associated with the manipulation is node N20.

When the requested manipulation involves duplication, nodes associated with the manipulation include a node (or a plurality of nodes) to be duplicated, and a node which is the parent of new node(s) created by the duplication manipulation. For example, in a manipulation for duplicating nodes N13, N14, N15 under node N20 illustrated in FIG. 36, nodes associated with the manipulation include nodes N13, N14, N15, N20.

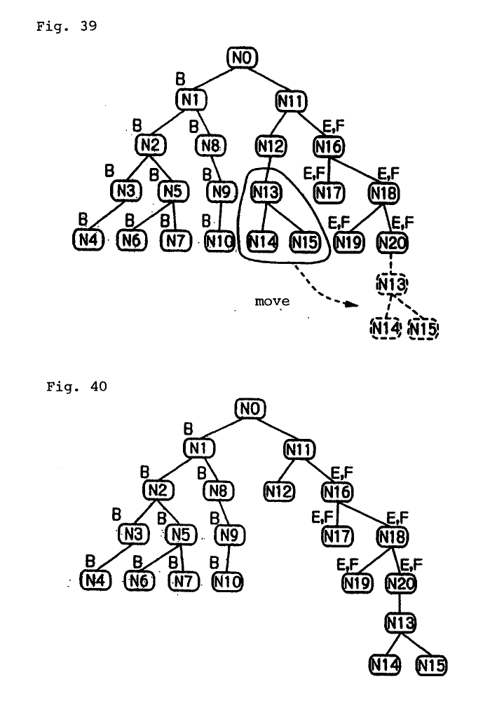

When the requested manipulation involves movement, nodes associated with the manipulation include a node to be moved, and nodes which belong to a maximum partial tree in which the node is in position of the root, and the parent node of the node to be moved, and a node which is the parent of the node after the movement. For example, in a manipulation for moving node N13 to a location under node N20 illustrated in FIG. 39, nodes N14, N15 subordinate to node N13 are also moved together with node N13. Therefore, nodes associated with the manipulation are nodes N12, N13, N14, N15, N20. However, depending on the operation policy of the information sharing system, it is also contemplated not to take into consideration the access rights of nodes N14, N15. In this event, nodes associated with the manipulation are nodes N12, N13, N20.

When the requested manipulation involves deletion of a node, nodes associated with the manipulation include a node (or a plurality of nodes) to be deleted, nodes included in maximum partial trees in which these nodes are in position of the root, and nodes which are the parents of the nodes to be deleted. For example, in a manipulation for deleting node N18 illustrated in FIG. 42, nodes belonging to a maximum partial tree in which node N18 is in position of the root, i.e., nodes N19, N20 are deleted together because they lose their parent. Therefore, nodes associated with the manipulation include nodes N18, N19, N20 and node N16 which is their parent.

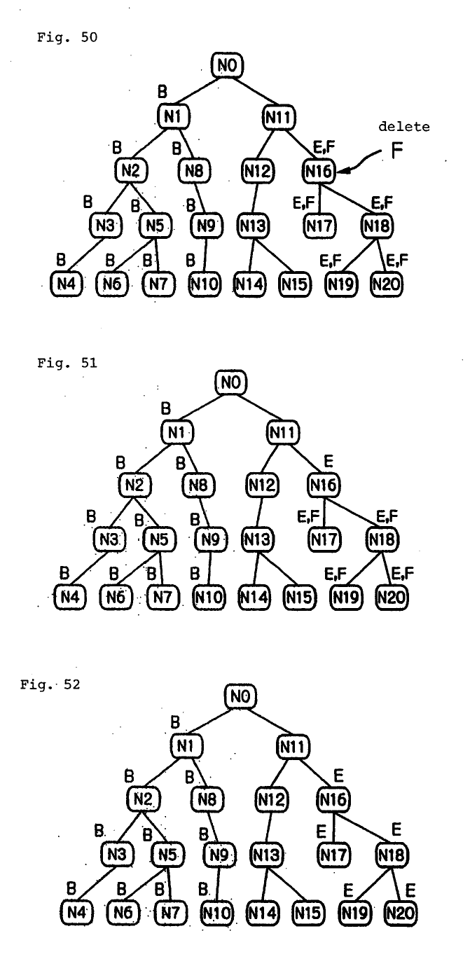

When the requested manipulation involves setting or clearing an access permitted party, nodes associated with the manipulation include a node to which an access permitted party is set or cleared, and nodes which belong to a maximum partial tree in which the node is in position of the root. For example, in a manipulation for setting unit user D as an access permitted party of node N13, illustrated in FIG. 44, nodes N14, N15 are also made available to unit user D for satisfying the condition. Therefore, nodes associated with the manipulation includes nodes N13, N14, N15. Also, in a manipulation for adding node D as an access permitted party to node N16, illustrated in FIG. 47, unit user D is also added to nodes N17, N18, N19, N20 as an access permitted party for satisfying the condition. Therefore, nodes associated with the manipulation includes nodes N16, N17, N18, N19, N20. Further, in a manipulation for deleting unit user F from access permitted parties of node N16 so that only unit user E is left as an access permitted party, illustrated in FIG. 50, nodes associated with the manipulation include nodes N16, N17, N18, N19, N20, as is the case in the aforementioned addition. Also, in a manipulation for clearing an access permitted party set in node N16, illustrated in FIG. 53, nodes associated with the manipulation include nodes N16, N17, N18, N19, N20, as is the case in the aforementioned addition and deletion.

A manipulation request which has passed the determination in access permission determination unit 6, i.e., a manipulation request which is permitted to be executed, is sent to an associated block depending on the requested manipulation.

When the manipulation request involves a read/write of content information, the manipulation request is sent to tree structure storage 9 and processed therein. When the manipulation request involves a tree structure manipulation, the manipulation request is sent to tree structure manipulation unit 12 and processed therein. When the manipulation request involves an availability condition manipulation, the manipulation request is sent to execution possibility determination unit 11 and processed therein.

Now, detailed description will be made of the processing performed when a manipulation request involves an availability condition manipulation.

The manipulation request is sent to execution possibility determination unit 11 which determines whether or not the manipulation can be executed.

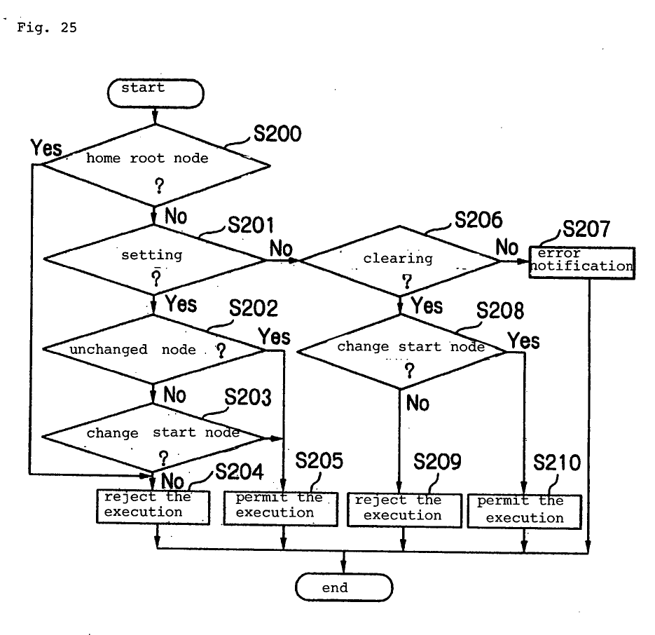

FIG. 25 is a flow chart illustrating the operation of execution possibility determination unit 11.

Upon receipt of a manipulation request, execution possibility determination unit 11 first determines whether or not a node under manipulation is a home root node (step S200). If the node under manipulation is a home root node, execution possibility determination unit 11 rejects the execution (step S204). If the node under manipulation is not a home root node, execution possibility determination unit 11 determines whether or not the manipulation request involves an availability setting manipulation (step S201).

If the manipulation request involves an availability setting manipulation, execution possibility determination unit 11 determines whether or not the node under manipulation is an unchanged node (step S202). If the node under manipulation is an unchanged node, execution possibility determination unit 11 permits the execution of the manipulation (step S205). If the node under manipulation is not an unchanged node, execution possibility determination unit 11 determines whether or not the node under manipulation is a change start node (step S203).

If the node under manipulation is a change start node, execution possibility determination unit 11 permits the execution of the manipulation (step S205). If the node under manipulation is not a change start node, execution possibility determination unit 11 rejects the execution of the manipulation (step S204).

If execution possibility determination unit 11 determines at step S201 that the manipulation request does not involve an availability setting manipulation, execution possibility determination unit 11 determines whether or not the manipulation request involves an availability clearing manipulation (step S206).

If the manipulation request does not involve an availability clearing manipulation, execution possibility determination unit 11 notifies an error (step S207). If the manipulation request involves an availability clearing manipulation, execution possibility determination unit 11 determines whether or not the node under manipulation is a change start node (step S208). If the node under manipulation is a change start node, execution possibility determination unit 11 permits the execution of the manipulation (step S210). If the node under manipulation is not a change start node, execution possibility determination unit 11 rejects the execution of the manipulation (step S209).

In conclusion, the availability setting manipulation must be directed to an unchanged node or a change start node other than a home root node. The availability clearing manipulation must be directed to a change start node.

The manipulation request, the execution of which is permitted in execution possibility determination unit 11, is sent to availability condition manipulation unit 13.

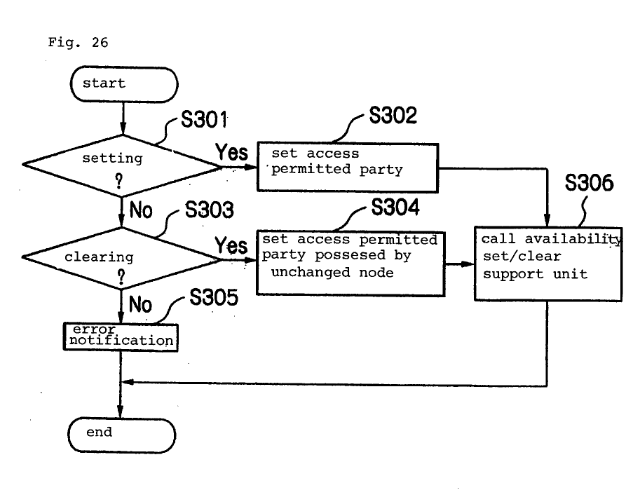

FIG. 26 is a flow chart illustrating the operation of availability condition manipulation unit 13.

Upon receipt of a manipulation request, availability condition manipulation unit 13 first determines whether or not the manipulation request involves an availability setting manipulation (step S301). If the manipulation request involves an availability setting manipulation, availability condition manipulation unit 13 finds a node under manipulation from tree structure storage 9, and sets an access permitted party for the node (S302).

If the manipulation request does not involve an availability setting manipulation, availability condition manipulation unit 13 determines whether or not the manipulation request involves an availability clearing manipulation (step S303). If the manipulation request involves an availability clearing manipulation, availability condition manipulation unit 13 sets an access permitted party possessed by an unchanged node to the node under manipulation (step S304).

After the processing at step S302 or S304, availability condition manipulation unit 13 calls availability set/clear support unit 21 (step S306).

If availability condition manipulation unit 13 determines at step S303 that the manipulation request is not an availability clearing manipulation, availability condition manipulation unit 13 notifies an error (step S305).

Now, the operation of availability condition manipulation unit 13 will be described in detail with reference to specific examples.

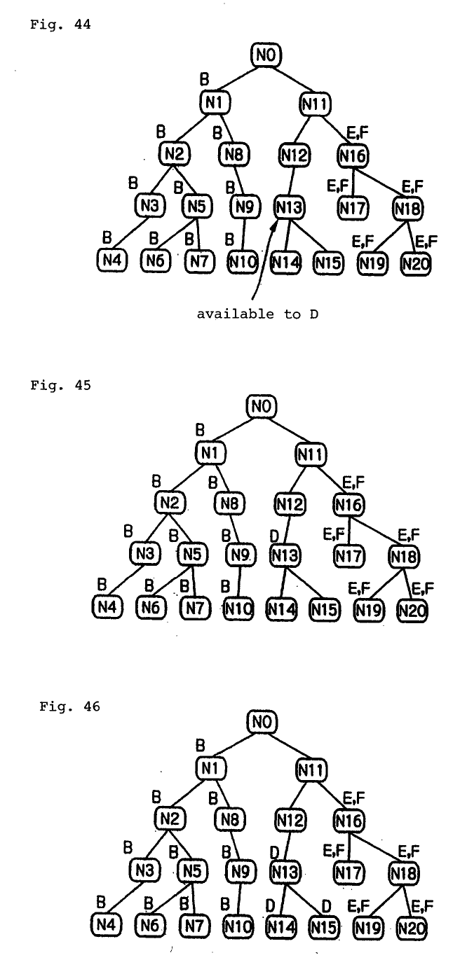

FIG. 44 illustrates an example in which unit user D is set as an access permitted party of node N13 which is an unchanged node. In this event, the flow in FIG. 26 follows the Yes path in response to the determination at step S301. Then, through the processing at step S302, availability condition manipulation unit 13 sets unit user D as an access permitted party of node N13, resulting in the tree structure and availability condition as illustrated in FIG. 45. Subsequently, availability condition manipulation unit 13 proceeds to step S306.

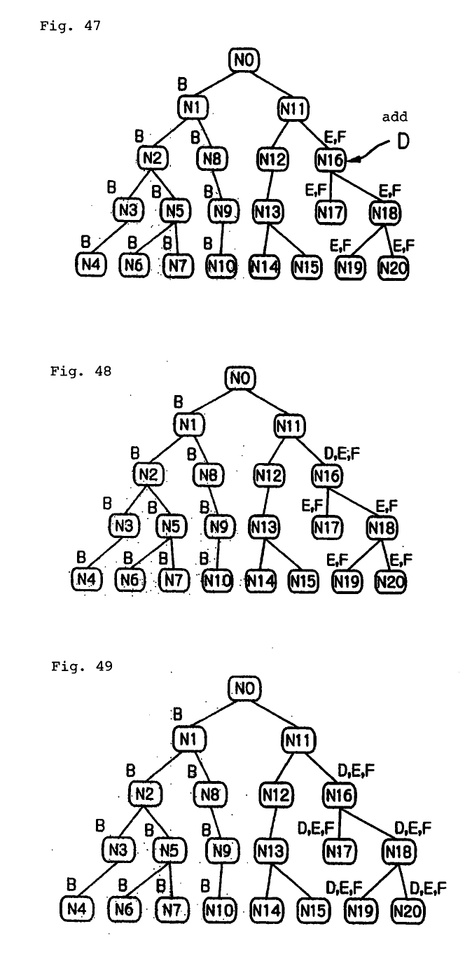

FIG. 47 illustrates an example in which unit user D is added as an access permitted party of change start node N16, so that change start node N16 is made available to unit users D, E, F. In this event, the flow in FIG. 26 follows the Yes path in response to the determination at step S301. Then, through the processing at step S302, availability condition manipulation unit 13 sets unit users D, E, F as access permitted parties of node N16, resulting in the tree structure and availability condition as illustrated in FIG. 48. Subsequently, availability condition manipulation unit 13 proceeds to step S306.

FIG. 50 illustrates an example in which unit user F is deleted from access permitted parties of change start node N16 to leave only unit user E which is permitted to access node N16. In this event, the flow in FIG. 26 follows the Yes path in response to the determination at step S301. Then, through the processing at step S302, availability condition manipulation unit 13 sets unit user E as an access permitted party of node N16, resulting in the tree structure and availability condition as illustrated in FIG. 51. Subsequently, availability condition manipulation unit proceeds to step S306.

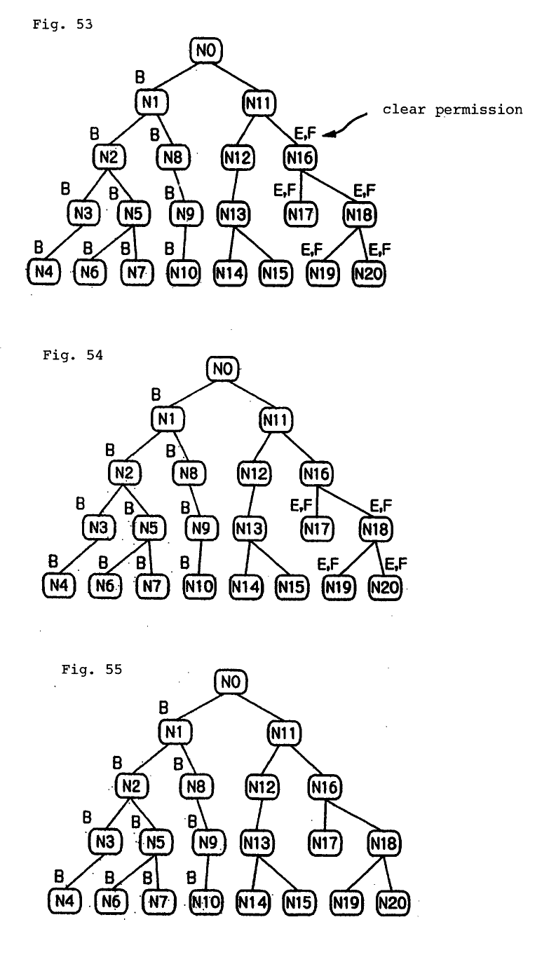

FIG. 53 illustrates an example in which the availability of change start node N16 is cleared. In this event, the flow in FIG. 26 follows the No path in response to the determination at step S301. Next, availability condition manipulation unit 13 first acquires access permitted parties of unchanged nodes in the processing at step S304. In the example of FIG. 53, the unchanged nodes (N0, N11, N12, N13, N14, N15) are not made available to any unit user, so that there is no access permitted party. For this reason, availability condition manipulation unit 13 acquires no access permitted party, and sets no access permitted party to node N16. This results in the tree structure and availability condition as illustrated in FIG. 54. Subsequently, availability condition manipulation unit 13 proceeds to step S306.

Next, detailed description will be made on a manipulation request which involves a tree structure manipulation.

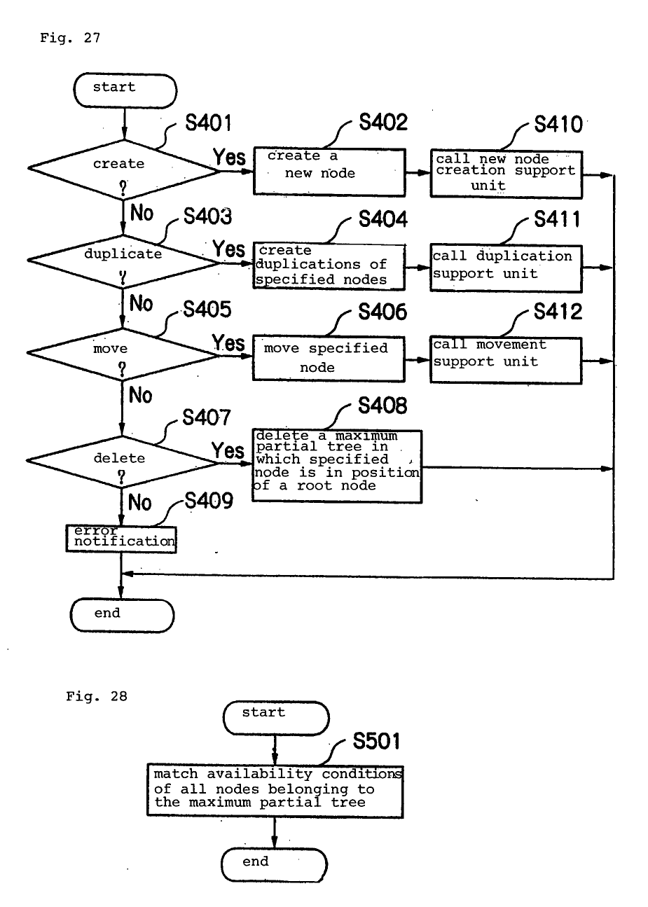

FIG. 27 is a flow chart illustrating the operation of tree structure manipulation unit 12.

As a request for manipulating a tree structure is sent from access permission determination unit 6 to tree structure manipulation unit 12, tree structure manipulation unit 12 classifies the manipulation request through determinations at steps S401, S403, S405, S407.

If it is determined at step S401 that the manipulation request involves creation of a new node, tree structure manipulation unit 12 creates a new node in tree structure storage 9 (step S402). Subsequently, tree structure manipulation unit 12 calls new node creation support unit 22 (step S410).

If it is determined at step S403 that the manipulation request involves duplication, tree structure manipulation unit 12 creates duplicates of specified nodes under a node which is specified as the destination (step S404). Subsequently, tree structure manipulation unit 12 calls duplication support unit 23 (step S411).

If it is determined at step S405 that the manipulation request involves movement, tree structure manipulation unit 12 moves specified nodes to a location under a node specified as the destination (step S406). Subsequently, tree structure manipulation unit 12 calls movement support unit 24 (step S412).

If it is determined at step S407 that the manipulation request involves deletion, tree structure manipulation unit 12 deletes a maximum partial tree in which a specified node is in position of the root (step S408).

If the manipulation request does not involve any of the foregoing, tree structure manipulation unit 12 notifies an error (step S409).

The operation of tree structure manipulation unit 12 will be described in detail with reference to specific examples.

FIG. 33 illustrates an example in which new node N21 is created under node N20. In this event, through the processing at step S402 in FIG. 27, node N21 is created under node N20, resulting in the tree structure and availability condition as illustrated in FIG. 34. Subsequently, tree structure manipulation unit 12 calls new node creation support unit 22 at step S410.

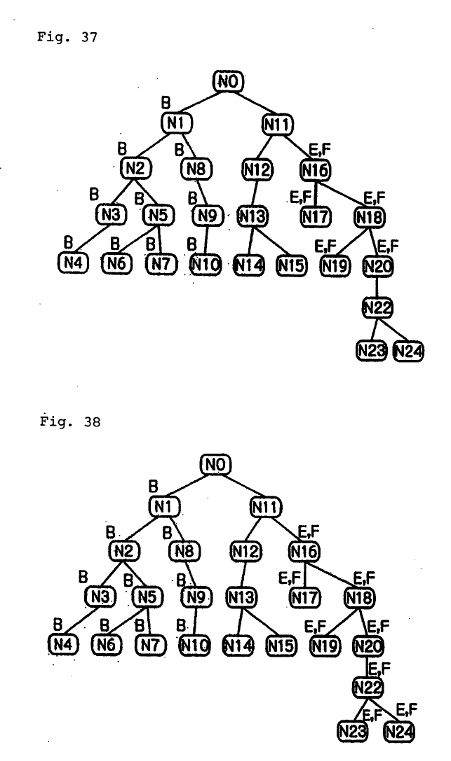

FIG. 36 illustrates an example in which duplicates of nodes N13, N14, N15 are created under node N20. In this event, through the processing at step S404 in FIG. 27, duplicated nodes N22, N23, N24 are created under node N20, resulting in the tree structure and availability condition as illustrated in FIG. 37. Subsequently, tree structure manipulation unit 12 calls duplication support unit 23 at step S411.

FIG. 39 illustrates an example in which nodes N13, N14, N15 are moved to a location under node N20. In this event, nodes N13, N14, N15 are moved to a location under node N20 at step S406 in FIG. 27, resulting in the tree structure and availability condition as illustrated in FIG. 40. Subsequently, tree structure manipulation unit 12 calls movement support unit 24 at step S412.

FIG. 42 illustrates an example in which node N18 is deleted. In this event, nodes belonging to a maximum partial tree in which node N18 is in position of the root, i.e., nodes N18, N19, N20 are deleted at step S408 in FIG. 27, resulting in the tree structure and availability condition as illustrated in FIG. 43.

FIG. 28 is a flow chart illustrating the operation of availability set/clear support unit 21.

In response to a call, availability set/clear support unit 21 sets access permitted parties held by a node under manipulation to all nodes belonging to a maximum partial tree in which the node under manipulation is in position of the root node, except for the node under manipulation (step S501).

The operation of availability set/clear support unit 21 will be described in detail with reference to specific examples.

As described above, FIG. 44 illustrates an example in which unit user D is set as an access permitted party of node N13 which is an unchanged node. After availability condition manipulation unit 13 has completed the processing, the resulting tree structure and availability condition have changed as illustrated in FIG. 45.

Here, availability set/clear support unit 21 sets unit user D specified as access permitted party of node N13 to nodes N14, N15 through the processing at step S501, resulting in the tree structure and availability condition as illustrated in FIG. 46.

As described above, FIG. 47 illustrates an example in which unit user D is added as an access permitted party of change start node N16, so that unit change start node N16 is made available to users D, E, F. After availability condition manipulation unit 13 has completed the processing, the resulting tree structure and availability condition have changed as illustrated in FIG. 48.

Here, as availability set/clear support unit 21 sets unit users D, E, F specified as access permitted parties of node N16 to nodes N17, N18, N19, N20 through the processing at step S501, resulting in the tree structure and availability condition as illustrated in FIG. 49.

As described above, FIG. 50 illustrates an example in which unit user F is deleted from access permitted parties of change start node N16 to leave only unit user E which is permitted to access node N16. As availability condition manipulation unit 13 has completed the processing, the resulting tree structure and availability condition have changed as illustrated in FIG. 51;

Here, as availability set/clear support unit 21 sets unit user E specified as an access permitted party of node N16 to nodes N17, N18, N19, N20 through the processing at step S501, resulting in the tree structure and availability condition as illustrated in FIG. 52.

As described above, FIG. 53 illustrates an example in which the availability of change start node N16 is cleared. As availability condition manipulation unit 13 has completed the processing, the resulting tree structure and availability condition have changed as illustrated in FIG. 54.

Here, availability set/clear support unit 21 sets no unit user specified as an access permitted party of node N16 to nodes N17, N18, N19, N20 through the processing at step S501, resulting in the tree structure and availability condition as illustrated in FIG. 55.

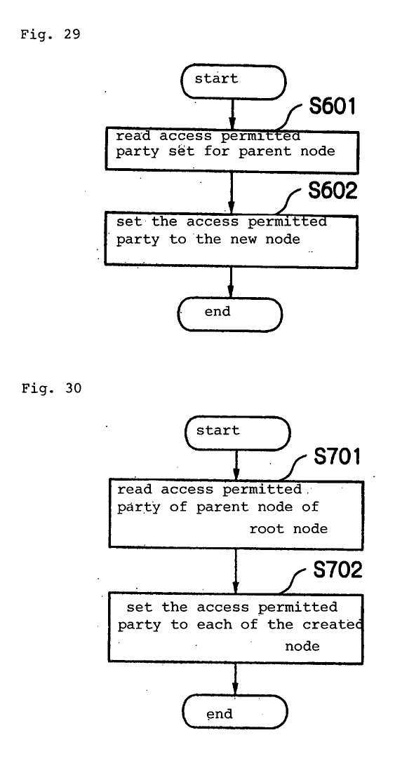

FIG. 29 is a flow chart illustrating the operation of new node creation support unit 22.

In response to a call, new node creation support unit 22 first reads access permitted parties set for a parent node of a newly created node (step S601). Next, new node creation support unit 22 sets the read access permitted parties to the newly created node (step S602).

The operation of new node creation support unit 22 will be described in detail with reference to specific examples.

As described above, FIG. 33 illustrates an example in which new node N21 is created under node N20 as a child node. After tree structure manipulation unit 12 has completed the processing, the resulting tree structure and availability condition have changed as illustrated in FIG. 34.

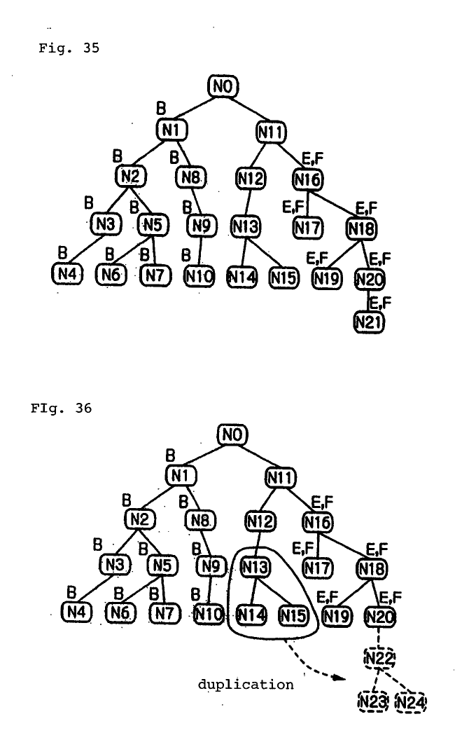

Here, new node creation support unit 22 reads unit users E, F, which are access permitted parties of node N20, through the processing at step S601, and sets unit users E, F to node N21 as access permitted parties through processing at step S602, resulting in the tree structure and availability condition as illustrated in FIG. 35.

FIG. 30 is a flow chart illustrating the operation of duplication support unit 23.

In response to a call, duplication support unit 23 finds the root node of nodes created by a duplication manipulation, and reads access permitted parties of its parent node (step S701). Next, duplication support unit 23 sets the read access permitted parties to each of the nodes created by the duplication manipulation (step S702).

The operation of duplication support unit 23 will be described in detail with reference to specific examples.

As described above, FIG. 36 illustrates an example in which a maximum partial tree in which node N13 is in position of the root (i.e., nodes N13, N14, N15) is duplicated to create nodes N22, N23, N24 which are placed under node N20. After tree structure manipulation unit 12 has completed the processing, the resulting tree structure and availability condition have changed as illustrated in FIG. 37.

Here, duplication support unit 23 reads unit users E, F, which are access permitted parties of node N20, through the processing at step S701, and sets unit users E, F to nodes N22, N23, N23 as access permitted parties through the processing at step S702, resulting in the tree structure and availability condition as illustrated in FIG. 38.

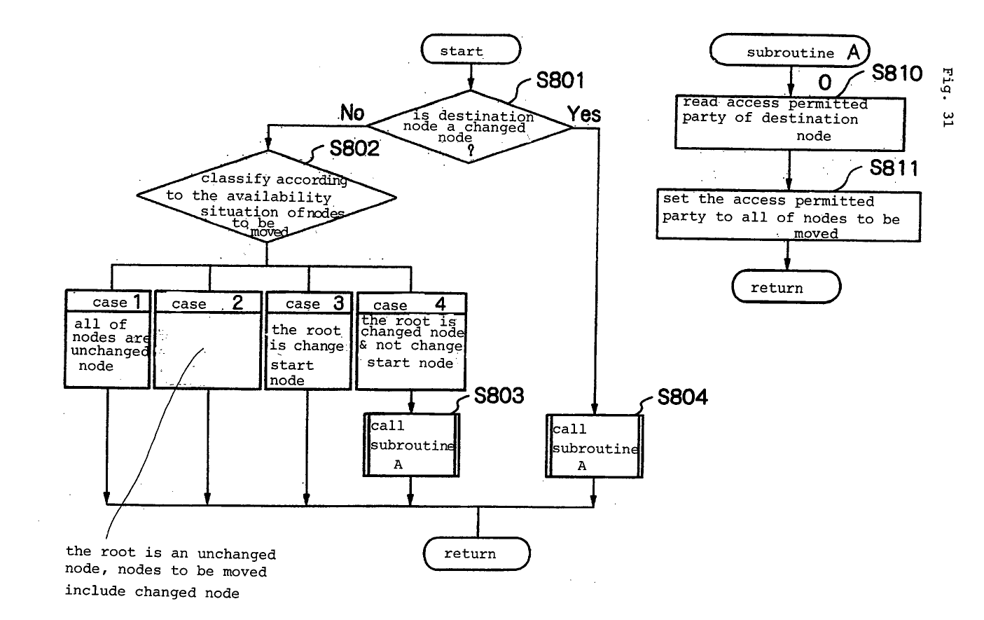

FIG. 31 is a flow chart illustrating the operation of movement support unit 24.

In response to a call, movement support unit 24 first determines whether or not a destination node is a changed node (step S801). If the destination node is a changed node, movement support unit 24 calls subroutine A (step S804).

Conversely, if the destination node is not a changed node, movement support unit 24 classifies a particular manipulation into Cases 1-4 according to the availability situation of nodes to be moved (step S802). Case 1 represents that all of nodes to be moved are unchanged nodes. Case 2 represents that nodes to be moved include changed nodes though the root is an unchanged node. Case 3 represents that the root of nodes to be moved is a change start node. Case 4 represents that nodes to be moved have the root which is a changed node and is not a change start node.

Movement support unit 24 determines whether or not subroutine A is called in accordance with Cases 1-4, and calls subroutine A as required (step S803). In this embodiment, subroutine A is called only when Case 4 is determined.

In subroutine A, movement support unit 24 first reads access permitted parties of the destination node (step S810). Next, movement support unit 24 sets the access permitted parties read at step S810 to all nodes to be moved (step S811).

In the foregoing embodiment, while subroutine A is called in response to Case 4 to set the same access permitted parties of the destination node to the nodes to be moved, different processing is contemplated depending on a particular design policy. The access permitted parties of nodes to be moved may be maintained, or the user may be queried as to whether the access permitted parties of the nodes to be moved should be maintained or replaced with access permitted parties of the destination node so that the same access permitted parties are set to the destination node and the nodes to be moved.

Also, in the foregoing embodiment, while subroutine A is not called in response to Case 3 to maintain access permitted parties of the nodes to be moved, different processing is contemplated depending on a particular design policy. The access permitted parties of the destination node may be set to the nodes to be moved so that they have the same access permitted parties as the destination node, or the user may be queried as to whether the access permitted parties of the nodes to be moved should be maintained or replaced with access permitted parties of the destination node so that the same access permitted parties are set to the destination node and the nodes to be moved.

Further, in the foregoing embodiment, while subroutine A is not called in response to Case 2 to maintain access permitted parties of the nodes to be moved, the access permitted parties of the destination node may be set to all nodes included in the nodes to be moved so that they have the same access permitted parties as the destination node, or the user may be queried as to whether the access permitted parties of the nodes to be moved should be maintained or replaced with access permitted parties of the destination node so that the same access permitted parties are set to the destination node and the nodes to be moved.

The operation of movement support unit 24 will be described in detail with reference to specific examples.

As described above, FIG. 39 illustrates an example in which nodes N13, N14, N15 are moved to a location under node N20. After tree structure manipulation unit 12 has completed the processing, nodes N13, N14, N15 are moved to a location under node N20, resulting in the tree structure and availability condition as illustrated in FIG. 40.

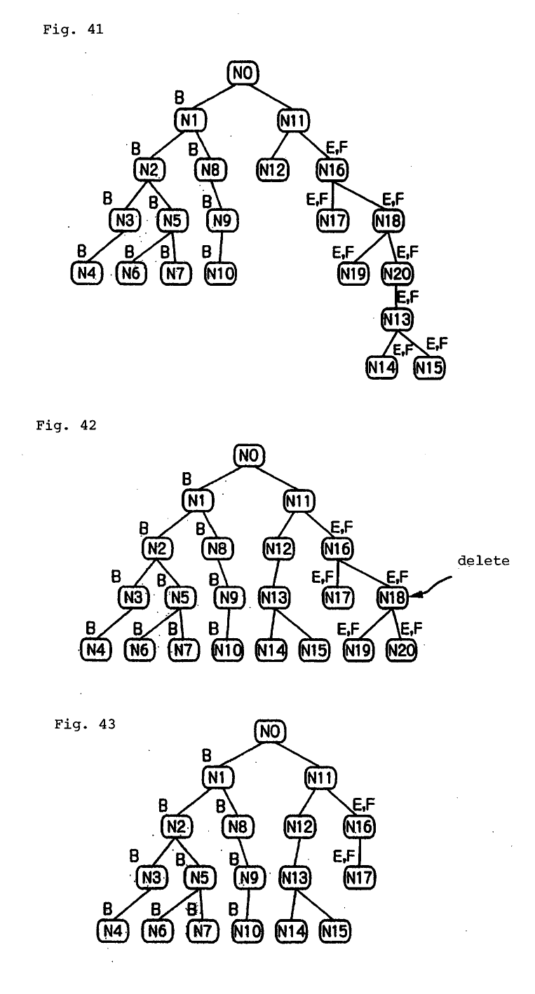

Here, the processing at step S804 in FIG. 31 by movement support unit 24 causes a change in tree structure and availability condition as illustrated in FIG. 41.

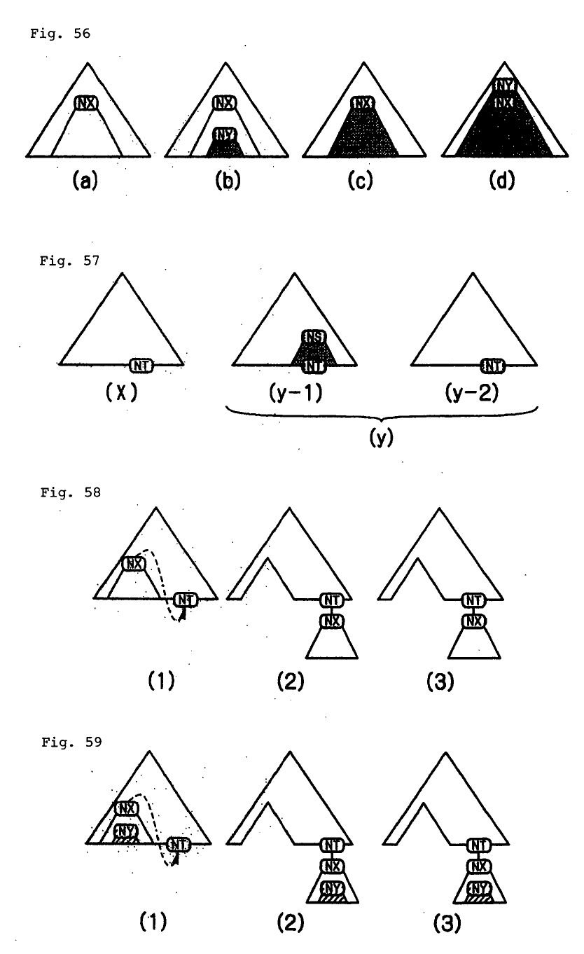

FIG. 56 illustrates how a movement manipulation is classified according to the availability condition of nodes to be moved. In this event, the classifications correspond to Cases 1-4 at step S802 in FIG. 31. In FIG. 56, nodes to be moved belong to a maximum partial tree in which node NX is in position of the root. The availability situation of the node to be moved are classified into the following four cases (a)-(d):

(a) all the nodes to be moved are unchanged nodes;

(b) the nodes to be moved have the root which is an unchanged node, but include a changed node therein;

(c) the nodes to be moved have the root node which is a change start node; and

(d) the nodes to be moved have the root which is a changed node and is not a change start node.

It should be noted that while FIG. 56(b) illustrates that there is one partial tree, the root of which is a changed node (i.e., a partial tree in which node NY is in position of the root), there may be a plurality of such partial trees.

FIG. 57 illustrates how a movement manipulation is classified according to the availability condition of a destination node. In this event, the classifications correspond to the determination at step S801 in FIG. 31. In FIG. 57, the destination node is node NT. The availability condition of the destination node is classified into two cases (x) and (y).

Case (x) represents that the destination node is an unchanged node, and Case (y) represents that the destination node is a changed node.

Case (y) further includes subcase (y−1) where the destination node is not a change start node, and subcase (y−2) where the destination node is a change start node. However, these two cases are regarded as identical because movement support unit 24 performs the same processing for these subcases.

Since there are four cases classified according to the node to be moved, and two cases classified according to the destination node, movement manipulations are classified into eight (4×2) possible cases which are called Cases 1-8.

In the following, the processing of movement support unit 24 will be described in the respective Cases.

FIG. 58 schematically illustrates Case 1. In Case 1, nodes to be moved fall under case (a), and a destination node falls under case (x). FIG. 58(1) shows the state before movement. FIG. 58(2) shows the state after tree structure manipulation unit 12 has completed the processing. FIG. 58(3) shows the state after movement support unit 24 has completed the processing. Since movement support unit 24 proceeds to Case 1 at step S802 in FIG. 31, subroutine A is not executed for setting an access permitted party.

FIG. 59 schematically illustrates Case 2. In Case 2, nodes to be moved fall under case (b), and a destination node falls under case (x). Since movement support unit 24 proceeds to Case 2 at step 802 in FIG. 31, subroutine A is not executed for setting an access permitted party.

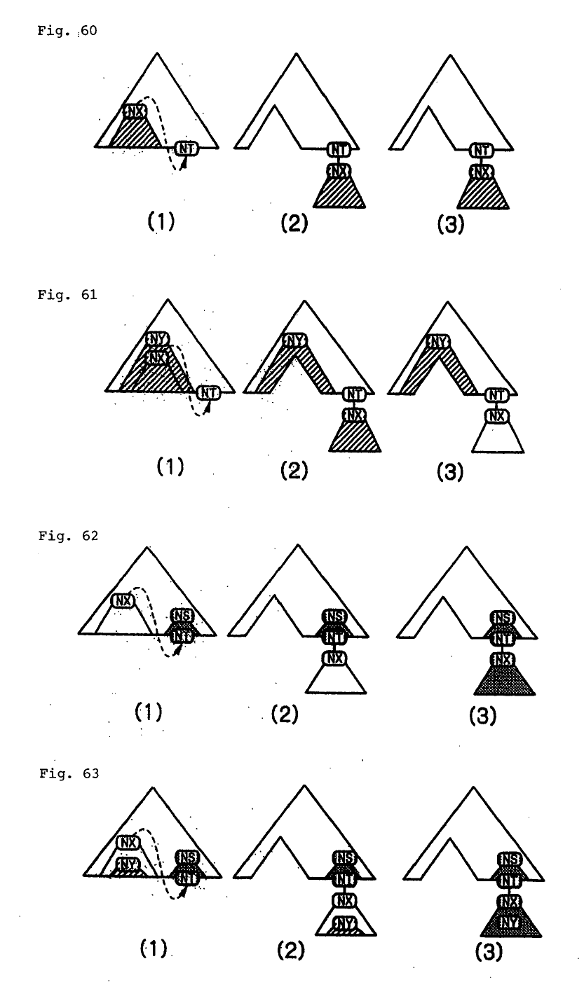

FIG. 60 schematically illustrates Case 3. In Case 3, nodes to be moved fall under case (c), and a destination node falls under case (x). Since movement support unit 24 proceeds to Case 3 at step S802 in FIG. 31, subroutine A is not executed for setting an access permitted party.

FIG. 61 schematically illustrates Case 4. In Case 4, nodes to be moved fall under case (d), and a destination node falls under case (x). Since movement support unit 24 proceeds to Case 4 at step S802 in FIG. 31, subroutine A is executed for setting an access permitted party (step S803). As a result, the moved nodes are all changed to unchanged nodes.

FIG. 62 schematically illustrates Case 5. In Case 5, nodes to be moved fall under case (a), and a destination node falls under case (y). Since movement support unit 24 proceeds to the Yes path from step S801 in FIG. 31, subroutine A is executed. As a result, the same access permitted parties of node NT are set to all the moved nodes.

FIG. 63 schematically illustrates Case 6. In Case 6, nodes to be moved fall under case (b), and a destination node falls under case (y). Since movement support unit 24 proceeds to the Yes path from step S801 in FIG. 31, subroutine A is executed. As a result, the same access permitted parties of node NT are set to all the moved nodes.

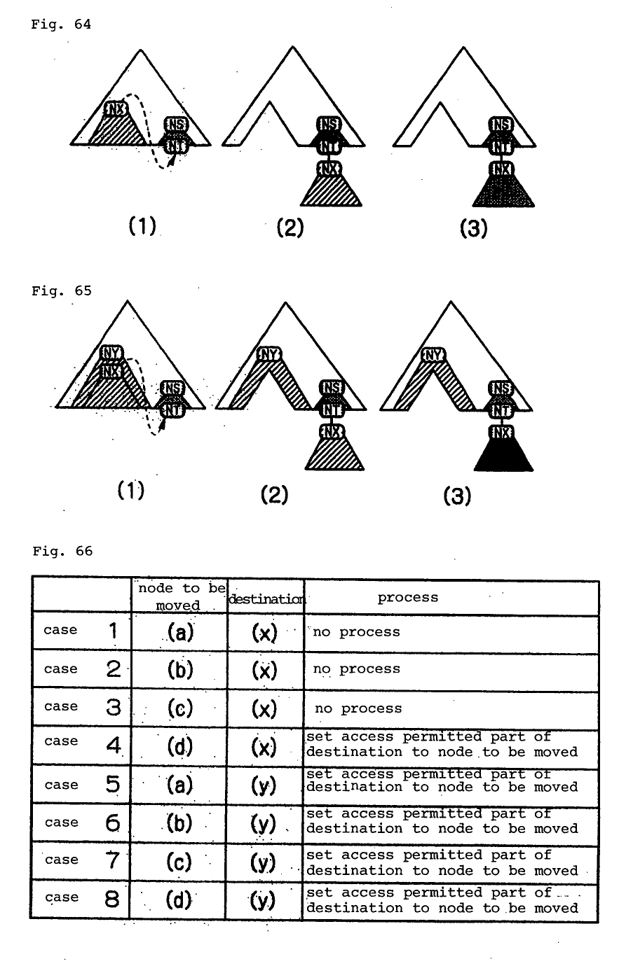

FIG. 64 schematically illustrates Case 7. In Case 7, nodes to be moved fall under case (c), and a destination node falls under case (y). Since movement support unit 24 proceeds to the Yes path from step S801 in FIG. 31, subroutine A is executed. As a result, the same access permitted parties of node NT are set to all the moved nodes.

FIG. 65 schematically illustrates Case 8. In Case 8, nodes to be moved fall under case (d), and a destination node falls under case (y). Since movement support unit 24 proceeds to the Yes path from step S801 in FIG. 31, subroutine A is executed. As a result, the same access permitted parties of node NT are set to all the moved nodes.

FIG. 66 is a table showing the processing performed by movement support unit 24 in respective Cases 1-8.

The contents of the processing in Cases 2, 3, 4 shown in this example are not the uniquely selectable processing, but may be replaced with other processing in accordance with the policy of a system designer.

For example, in regard to Case 3, FIG. 66 shows that no processing is performed. However, an access permitted party of the destination node may be set to all nodes to be moved based on a design policy that all the nodes to be moved should naturally be changed to unchanged nodes because they are moved to a location under an unchanged node. In doing so, the flow chart of FIG. 31 may be modified such that subroutine A is called at step S802 in Case 3. Alternatively, the user may be queried as to whether an access permitted party of the nodes to be moved should be maintained or replaced with the access permitted party of the destination node so that the same access permitted party is set to the destination node and the nodes to be moved.

As described above, the information sharing system according to this embodiment satisfies at all times the condition that on any of paths from the root node to respective leaf nodes in a tree structure, the access permitted party should be changed once at maximum. This is realized by execution possibility determination unit 11 which rejects any manipulation which violates the condition, and constraint maintenance unit 20 which sets and changes an access permitted party for each of nodes in a tree structure such that the condition is satisfied when the tree structure is manipulated or when the availability condition is changed.

Consequently, the user can understand the availability condition over the whole tree structure only by examining the presence or absence of a single change start node at maximum, and its position in each of paths from the root node to respective leaf nodes, without the need for examining the availability condition of all the nodes. The number of change start nodes in each path is determined to be one at maximum. If two or more change start nodes existed on a path, the resulting availability condition within the tree structure would become too complicated for the user to readily understand. Also, the user only needs to examine the presence or absence of a change start node, and its position, if present, to readily determine how the availability condition of a particular node changes in response to a manipulation on the tree structure or a manipulation on the availability condition.

Specifically, in this embodiment, when a node under manipulation is an unchanged node or a change start node, an access permitted party can be set to the node under manipulation. Also, when a node under manipulation is a change start node, an access permitted party can be cleared in the node under manipulation. In addition, a manipulation prohibited on the availability condition of the home root node. For setting the availability condition, the same availability condition is set to a node under manipulation and all nodes belonging to a maximum partial tree in which the node under manipulation is in position of the root. For clearing an access permitted party, the foregoing condition is satisfied by clearing the availability condition of the node under manipulation and all nodes belonging to the maximum partial tree in which the node under manipulation is in position of the root. Also, when a new node is created in response to a request, the same availability condition as the parent node is set to the created node. Further, when duplicates of nodes are created in response to a request, all nodes included in the duplicated nodes are forced to have the same availability condition as that of the parent node of the root node to which the duplicated nodes are placed.

The foregoing condition can be satisfied at all times by the foregoing strategy, thereby helping the user know the current availability condition, and an availability condition after a desired manipulation.

Specifically, in this embodiment, when nodes are moved in response to a request, the availability conditions of all nodes included in the moved nodes undergo preferable processing in accordance with a particular design policy depending on the availability condition of a destination node and/or the availability conditions of the nodes included in moved nodes. Also, preferable processing in accordance with a particular design policy is performed depending on the availability condition of the destination node and/or the availability conditions of the nodes included in the moved nodes to determine whether the availability conditions of the nodes included in the moved nodes should be maintained or replaced with the availability condition of the destination node, or whether or not the user is queried as to such selection.

While the information sharing system illustrated in the foregoing embodiment provides a file management configuration in which the homes of respective unit users exist independently of one another, as illustrated in FIG. 12, the present invention is not limited to such a system. The present invention can be applied to any system which is only required to hold and manage information owned by each unit user in a tree structure and in which the home of each unit user may form part of a larger overall tree.

Another embodiment of the present invention will be described with reference to the drawings.

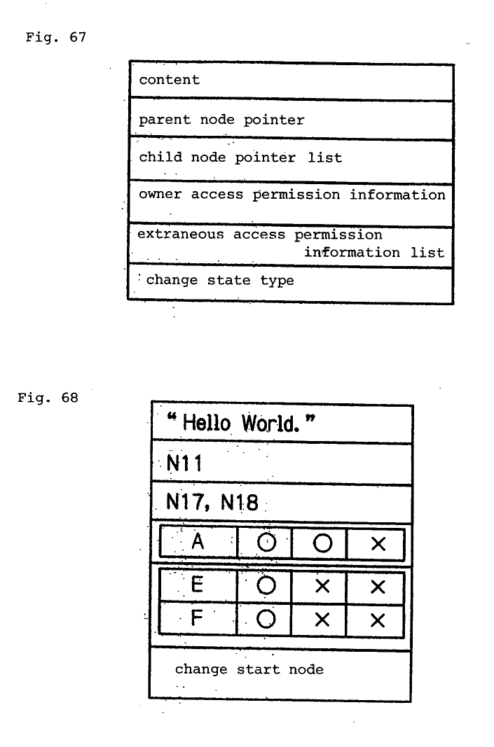

FIG. 67 is a table showing an exemplary data structure for each of nodes managed by an information sharing system according to another embodiment of the present invention. In FIG. 67, “change state type” is added to the data structure shown in FIG. 20. The change state type indicates whether or not an access permitted party changes at any node from the home root node to a local node itself, and also indicates, when it changes, whether or not the access permitted party changes between the parent node and local node. The change state type may take three possible alternatives: “unchanged node,” “change start node,” and “change takeover node.” The “change takeover node” is a changed node which is not a change start node.

FIG. 68 is a diagram showing an example of information stored in a node when the data structure shown in FIG. 67 is used. Specifically, FIG. 68 shows an example of information stored in node N16 in FIG. 13.

According to this embodiment, since information on the change state type is included in a node, it can be readily determined with reference to the change state type whether the node is an unchanged node, a change start node, or a change takeover node.

A further embodiment of the present invention will be described with reference to the drawings.

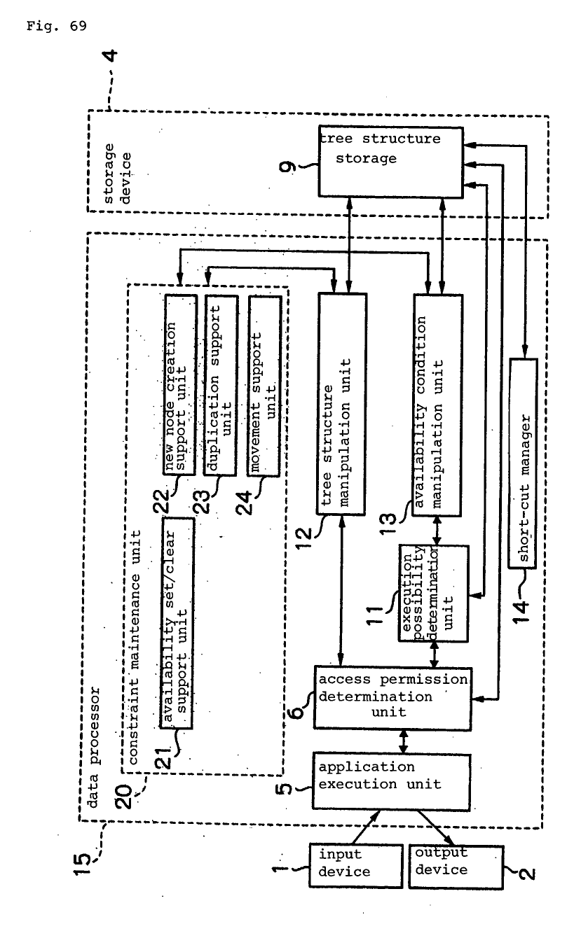

FIG. 69 is a block diagram illustrating the configuration of an information sharing system according to a further embodiment of the present invention. Referring to FIG. 69, data processor 15 in the information sharing system of this embodiment differs from data processor 10 in FIG. 19 in that the former has short-cut manager 14.

Short-cut manager 14 has a function of creating a short-cut for a specified node, and a function of searching a referenced node when a shortcut is specified.

A node on a short-cut is a node which calls another node that is referenced, and can be handled completely in the same manner as a normal node except that it is always a leaf node in a tree structure. Therefore, all processing executable by data processor 10 in the embodiment of FIG. 19 can be executed by data processor 15 in the embodiment of FIG. 69.

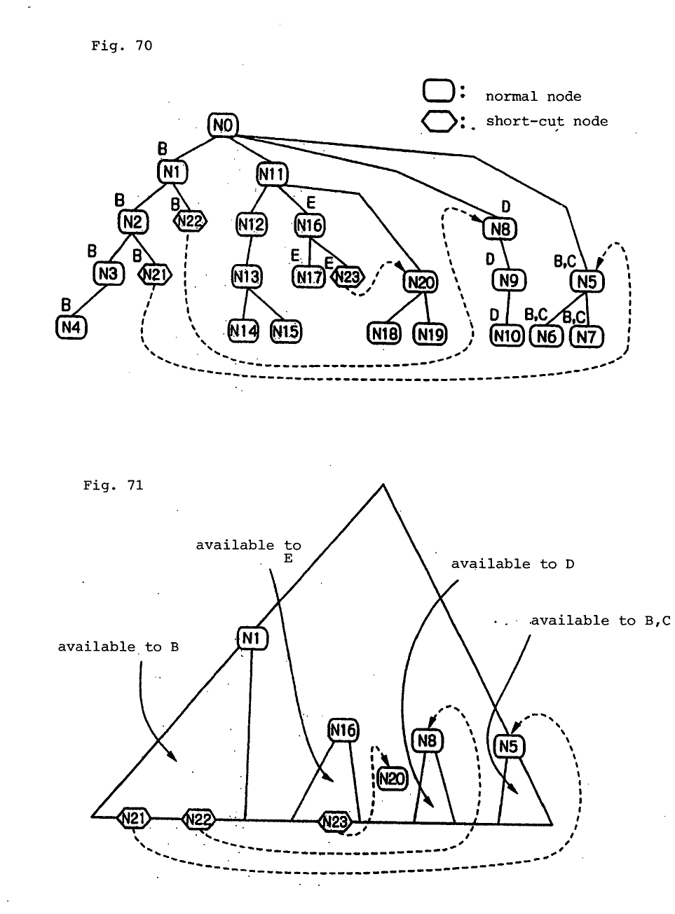

FIG. 70 is a diagram illustrating an exemplary availability situation of nodes when short-cuts are used. FIG. 71 is a simplified representation of the availability situation illustrated in FIG. 70.

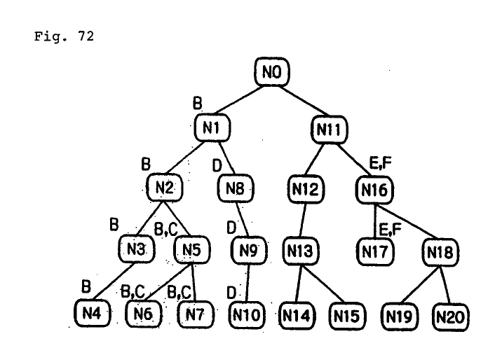

Data processor 15 in the embodiment of FIG. 69 can show a tree structure in which availability conditions are nested, as illustrated in FIG. 72, to unit users while still maintaining the condition that an access permitted party changes once at maximum on any of paths from a root node to respective leaf nodes in a tree structure, by use of the short-cuts as illustrated in FIGS. 70, 71.

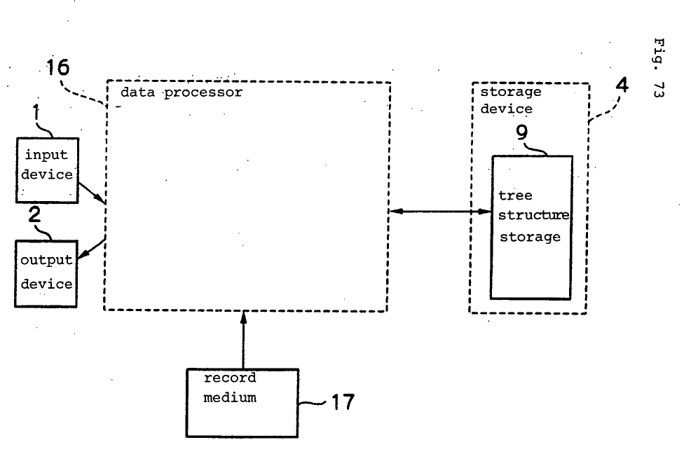

A further embodiment of the present invention will be described with reference to FIG. 73.

FIG. 73 is a block diagram illustrating the configuration of an information sharing system according to a further embodiment of the present invention. Referring to FIG. 73, data processor 16 in this embodiment is a computer which can be connected to recording medium 17. Recording medium 17 may be a magnetic disk, a semiconductor memory, or another recording medium on which an information sharing program is recorded.

The information sharing program is read into data processor 16 from recording medium 17. Data processor 16 executes the information sharing program to perform the same processing as the data processor 15 shown in FIG. 69.

While preferred embodiments of the present invention have been described using specific terms, such description is for illustrative purposes only, and it is to be understood that changes and variations may be made without departing from the spirit or scop of the following claims.

What is claimed is:

1. An information sharing method for holding information owned by at least one unit user on a storage device in a tree structure provided for each unit user, said tree structure including a plurality of nodes sequentially arranged from a home root node to at least one leaf node, such that said information corresponds to each of said nodes, to manage an availability condition of each of said nodes, said method comprising:
a first step in which a computer refers to the availability condition of each of said nodes on said storage device in response to an availability condition manipulation request for changing the availability condition of some node, to determine whether or not said availability condition manipulation request can be executed while satisfying a condition that the number of times of changes in the availability condition is limited to one at maximum on any of paths from said home root node to said respective leaf nodes;
a second step in which said computer executes the availability condition manipulation request such that said condition is satisfied when the availability condition manipulation request is determined as executable in said first step; and
a third step in which said computer refers to said availability condition in response to a tree structure manipulation request for modifying said tree structure, and executes the tree structure manipulation request such that said condition is satisfied.

2. The information sharing method according to claim 1, wherein said first step includes:
when said availability condition manipulation request involves setting an availability condition, determining that said availability condition manipulation request is executable when the availability condition of a node under manipulation is the same as that of the home root node, or is a change start point of the availability condition in said tree structure, and determining that said availability condition manipulation request is not executable when the availability condition of said node under manipulation is different from that of said home root node, and is not said change start point.

3. The information sharing method according to claim 1, wherein said first step includes:
when said availability condition manipulation request involves clearing an availability condition, determining that said availability condition manipulation request is executable when a node under manipulation is a change start point of the availability condition in said tree structure, and determining that said availability condition manipulation request is not executable when said node under manipulation is not said change start point.

4. The information sharing method according to claim 1, wherein said first step includes:
determining that said availability condition manipulation request is not executable when a node under manipulation intended by said availability condition manipulation request is a home root node.

5. The information sharing method according to claim 1, wherein said second step includes:
when said availability condition manipulation request involves setting an availability condition, setting the availability condition of a node under manipulation as requested by said availability condition manipulation request, and setting the same availability condition to all nodes included in a maximum partial tree in which said node under manipulation is in position of a root.

6. The information sharing method according to claim 1, wherein said second step includes:
when said availability condition manipulation request involves clearing availability condition, clearing the availability of a node under manipulation, and setting the same availability condition as that of said node under manipulation to all nodes included in a maximum partial tree in which said node under manipulation is in position of a root.

7. The information sharing method according to claim 1, wherein said third step includes:
when said tree structure manipulation request involves creating a new node, creating said new node at a requested location.

8. The information sharing method according to claim 7, wherein said third step further includes:
setting the same availability condition of a parent node of said new node to said new node after creating said new node.

9. The information sharing method according to claim 1, wherein said third step includes:
when said tree structure manipulation request involves duplicating a node group comprising at least one node, creating a duplicate of said node group at a requested location.

10. The information sharing method according to claim 9, wherein said third step further includes:
setting the same availability condition set to the parent node of a root node of said node group to said nodes which make up the duplicate of said node group after creating the duplicate of said node group.

11. The information sharing method according to claim 1, wherein said third step includes:
when said tree structure manipulation request involves moving a node group comprising at least one node, moving said node group to a location under a requested destination node.

12. The information sharing method according to claim 11, wherein said third step further includes:
performing different processing depending on the availability condition of each of said nodes included in said node group after moving said node group.

13. The information sharing method according to claim 12, wherein said processing is one of first processing for maintaining the availability condition of each of said nodes included in said node group, second processing for setting the same availability condition of said destination node to each of said nodes, and third processing for querying a user whether said first processing or said second processing is performed, and performing the one selected by the user.

14. The information sharing method according to claim 11, wherein said third step further includes:
performing different processing depending on whether the availability condition of said destination node is different from that of the home root node after moving said node group.

15. The information sharing method according to claim 14, wherein said processing is one of first processing for maintaining the availability condition of each of said nodes included in said node group, second processing for setting the same availability condition of said destination node to each of said nodes, and third processing for querying a user whether said first processing or said second processing is performed, and performing the one selected by the user.

16. The information sharing method according to claim 14, wherein said third step further includes:
performing different processing depending on the availability condition of each of said nodes included in said node group after moving said node group.

17. The information sharing method according to claim 16, wherein said processing is one of first processing for maintaining the availability condition of each of said nodes included in said node group, second processing for setting the same availability condition of said destination node to each of said nodes, and third processing for querying a user whether said first processing or said second processing is performed, and performing the one selected by the user.

18. The information sharing method according to claim 1, wherein each of said nodes in said tree structure is classified into an unchanged node having the same availability condition as the home root node, a change start node having an availability condition different from that of said home root node and different from that of a parent node; and a change takeover node having an availability condition different from that of said home root node and the same as that of a parent node, said classification being added to information on said availability condition as a change state type of each of said nodes for management, wherein:
said computer refers to said change state type for examining said availability condition.

19. The information sharing method according to claim 1, wherein said tree structure includes a node which is a short-cut to another node.

20. An information sharing apparatus for holding information owned by at least one unit user on a storage device in a tree structure provided for each unit user, said tree structure including a plurality of nodes sequentially arranged from a home root node to at least one leaf node, such that said information corresponds to each of said nodes, to manage an availability condition of each of said nodes, said apparatus comprising:
execution possibility determining means, responsive to an availability condition manipulation request for changing the availability condition of some node, for referring the availability condition of each of said nodes on said storage device to determine whether or not said availability condition manipulation request can be executed while satisfying a condition that the number of times of changes in the availability condition is limited to one at maximum on any of paths from said home root node to said respective leaf nodes;
availability condition manipulating means for executing the availability condition manipulation request such that said condition is satisfied when said execution possibility determining means determines that the availability condition manipulation request is executable; and
tree structure manipulating means, responsive to a tree structure manipulation request for modifying said tree structure, for referring to said availability condition to execute the tree structure manipulation request such that said condition is satisfied.

21. The information sharing apparatus according to claim 20, wherein said execution possibility determining means is operative when said availability condition manipulation request involves setting an availability condition to determine that said availability condition manipulation request is executable when the availability condition of a node under manipulation is the same as that of the home root node, or is a change start point of the availability condition in said tree structure, and to determine that said availability condition manipulation request is not executable when the availability condition of said node under manipulation is different from that of said home root node, and is not said change start point.

22. The information sharing apparatus according to claim 20, wherein said execution possibility determining means is operative when said availability condition manipulation request involves clearing an availability condition to determine that said availability condition manipulation request is executable when a node under manipulation is a change start point of the availability condition in said tree structure, and to determine that said availability condition manipulation request is not executable when said node under manipulation is not said change start point.

23. The information sharing apparatus according to claim 20, wherein said execution possibility determining means determines that said availability condition manipulation request is not executable when a node under manipulation intended by said availability condition manipulation request is a home root node.

24. The information sharing apparatus according to claim 20, further comprising availability condition setting supporting means, when called from said availability condition manipulating means, for setting the same availability condition of a node under manipulation to all nodes included in a maximum partial tree in which said node under manipulation is in position of a root,
wherein said availability condition manipulating means is operative when said availability condition manipulation request involves setting an availability condition to set the availability condition of a node under manipulation as requested by said availability condition manipulation request, and to call said availability condition setting supporting means.

25. The information sharing apparatus according to claim 20, further comprising availability condition clear supporting means, when called from said availability condition manipulating means, for setting the same availability condition of a node under manipulation to all nodes included in a maximum partial tree in which said node under manipulation is in position of a root,
wherein said availability condition manipulating means is operative when said availability condition manipulation request involves clearing availability condition to clear the availability of a node under manipulation, and to call said availability condition clear supporting means.

26. The information sharing apparatus according to claim 20, wherein said tree structure manipulating means is operative when said tree structure manipulation request involves creating a new node to create said new node at a requested location.

27. The information sharing apparatus according to claim 26, further comprising new node creation supporting means, when called from said tree structure manipulating means, for setting the same availability condition of a parent node to said new node,
wherein said tree structure manipulating means calls said new node creation supporting means after creating said new node.

28. The information sharing apparatus according to claim 20, wherein said tree structure manipulating means is operative when said tree structure manipulation request involves duplicating a node group comprising at least one node to create a duplicate of said node group at a requested location.

29. The information sharing apparatus according to claim 28, further comprising duplication supporting means, when called from said tree structure manipulating means, for setting the same availability condition set to the parent node of a root node of said node group to said nodes which make up the duplicate of said node group,
wherein said tree structure manipulating means calls said duplication supporting means after creating the duplicate of said node group.

30. The information sharing apparatus according to claim 20, wherein said tree structure manipulating means is operative when said tree structure manipulation request involves moving a node group comprising at least one node to move said node group to a location under a requested destination node.

31. The information sharing apparatus according to claim 30, further comprising movement supporting means, when called from said tree structure manipulating means, for performing different processing depending on the availability condition of each of said nodes included in said node group,
wherein said tree structure manipulating means calls said movement supporting means after moving said node group.

32. The information sharing apparatus according to claim 31, wherein said processing performed by said movement supporting means is one of first processing for maintaining the availability condition of each of said nodes included in said node group, second processing for setting the same availability condition of said destination node to each of said nodes, and third processing for querying a user whether said first processing or said second processing is performed, and performing the one selected by the user.

33. The information sharing apparatus according to claim 31, wherein said movement supporting means further performs different processing depending on the availability condition each of said nodes included in said node group.

34. The information sharing apparatus according to claim 33, wherein said processing performed by said movement supporting means is one of first processing for maintaining the availability condition of each of said nodes included in said node group, second processing for setting the same availability condition of said destination node to each of said nodes, and third processing for querying a user whether said first processing or said second processing is performed, and performing the one selected by the user.

35. The information sharing apparatus according to claim 20, wherein each of said nodes in said tree structure is classified into an unchanged node having the same availability condition as the home root node, a change start node having an availability condition different from that of said home root node and different from that of a parent node; and a change takeover node having an availability condition different from that of said home root node and the same as that of a parent node, said classification being added to information on said availability condition as a change state type of each of said nodes for management, wherein:
said information sharing apparatus refers to said change state type for examining said availability condition.

36. The information sharing apparatus according to claim 20, further comprising short-cut managing means for creating a node which is a short-cut to a referenced node, said short-cut managing means being responsive to designation of said short-cut node for searching said referenced node.

37. An information sharing program for causing a computer to hold information owned by at least one unit user on a storage device in a tree structure provided for each unit user, said tree structure including a home root node, at least one leaf node, and a plurality of nodes sequentially arranged from the home root node to each leaf node, such that said information corresponds to each of said nodes, to manage an availability condition of each of said nodes, said information sharing program comprising:
first processing for referring to the availability condition of each of said nodes on said storage device in response to an availability condition manipulation request for changing the availability condition of some node, to determine whether or not said availability condition manipulation request can be executed while satisfying a condition that the number of times of changes in the availability condition is limited to one at maximum on all paths from said home root node to said respective leaf nodes;
second processing for executing the availability condition manipulation request such that said condition is satisfied when the availability condition manipulation request is determined as executable in said first processing; and
third processing for referring to said availability condition in response to a tree structure manipulation request for modifying said tree structure, and executing the tree structure manipulation request such that said condition is satisfied.
